(19) United States
(12) Patent Application Publication
(10) Pub. No.: US 2012/0185348 A1
(43) Pub. Date: Jul. 19, 2012

(54) Systems and Methods for Implementing Iterated Sealed-Bid Auctions

(75) Inventor: Paul R. Milgrom, Stanford, CA (US)

(73) Assignee: AUCTIONOMICS, INC., Palo Alto, CA (US)

(21) Appl. No.: 13/353,280

(22) Filed: Jan. 18, 2012

Related U.S. Application Data
(60) Provisional application No. 61/433,938, filed on Jan. 18, 2011.

(51) Int. Cl. G06Q 30/08

(52) U.S. Cl. 705/26.3

(57) ABSTRACT

The present invention is directed to implementing iterated sealed-bid auctions of several types of products or several varieties of a single product simultaneously in order to encourage select bidders to place more and higher bids. Sellers therefore receive higher prices and products or services are more likely to be efficiently assigned. In general, iterated sealed-bid auctions are auctions in which bidders may make a variety of offers involving different prices and the final prices and allocation are determined according to the rules of a sealed-bid auction, but in which bidders may receive some feedback from initial rounds of bidding in the iterated sealed-bid auctions and have some opportunity to improve their price offers.

### CROSS REFERENCE TO RELATED APPLICATIONS

The present application claims the benefit of priority under 35 U.S.C. §119(e) of U.S. Provisional Application No. 61/433,938 entitled “Two-stage and Multi-stage MaaX,” filed on Jan. 18, 2011, by Paul R. Milgrom. The entire contents of the provisional application are incorporated by reference herein.

### BACKGROUND OF THE INVENTION

1. Field of the Invention

The present invention relates to on-line systems and methods for the exchange of products (or goods) or services. More particularly, the present invention relates to on-line systems and methods for implementing iterated sealed-bid auctions of several types of products or several varieties of a single product simultaneously.

2. Description of the Related Art

There has recently been significant growth in the importance of dynamic pricing of market goods of many kinds. At the low end, eBay has clearly established the value of auctions for consumers to buy and sell individual items on the Internet. EBay has made important advances in many areas, including highly effective search, reputation and payment systems, dispute resolution and fraud prevention process, and others. Their auction design itself, however, remains unremarkable but effective, since most of the goods for sale are marketed one at a time. Auctions are conducted with a fixed deadline, and ascending bids are taken up to the deadline. A proxy bidder is available, and a particular variant, a Dutch auction design, is available for the small subset of items in which multiples units are available.

At the other extreme, auctions have been used effectively by the United States and other countries as well as other entities to sell radio spectrum licenses, mineral rights, and more, via financial houses to sell shares in firms and other investment instruments, and via web firms, most successfully Google, to sell advertisement space. Such auctions transact billions of dollars, often in highly complex, integrated, and orchestrated events.

The problem of communication complexity is endemic to trade and resource allocation: any mechanism that promotes gains from trade must elicit sufficient information from participants in order to identify who wants what. Reducing the complexity of the information that must be elicited for efficient exchange is among the most important practical problems facing mechanism designers. For example, in the National Resident Matching Program (NRMP), which places doctors into hospital residency programs (Roth and Peranson (1999)), for a hospital that interviews fifty candidates in the hopes of employing ten to report its preferences fully, it must rank, from most-to-least-preferred, not simply all fifty candidates, but rather all possible subsets of ten or fewer doctors from among the fifty. Such a rank-order list would have approximately 1.3×10¹⁰ entries! In the recently completed FCC auction 73, which sold 1090 radio spectrum licenses, a value report for all non-empty collections of licenses is a vector of dimension 2¹⁰⁹⁰−1≈1.3×10³²⁸. These examples illustrate the lengthy report problem which, for moderate sized applications, renders useless any mechanism that demands full, unstructured reporting of preferences.

There are two approaches to mitigating the lengthy report problem, each of which is represented in some of the prior art. The first approach is to simplify the set of reports to reduce the reporting burden on participants. For example, hospitals in the NRMP do report rank order lists of individual candidates together with a number of available positions, rather than lists of sets of candidates. In our example from the preceding paragraph, a list of candidates has a length of only fifty, which is practically manageable, and the NRMP algorithm imputes preferences over sets of candidates to make use of the limited reports. This simplification has performed well enough to be continued for a long period of years. Nevertheless, Internet discussion groups detailing annoying limitations of the NRMP system remind us that its restrictions on preference reporting are quite real.

In mechanism design theory, the term “simplification” refers to a mechanism that is obtained from some original “extended” mechanism by restricting the reports available to participants. In a simplification, it is possible that for some preferences, some profiles of reports that were not Nash equilibria of the original unrestricted mechanism can be Nash equilibria of the simplified mechanism. These additional equilibria may have very different properties from the equilibria of the original mechanism, fundamentally changing the character of the mechanism. A simplification is tight if, for a wide set of specifications of preferences of the mechanism participants, all the pure Nash equilibria of the new mechanism are Nash equilibria of the original mechanism. Tightness is an important property of a simplified mechanism because it guarantees that the simplification preserves some key properties of the original mechanism.

The second pure approach to the lengthy report problem is to employ a dynamic mechanism with staged reporting of information. Such mechanisms economize reporting by asking only for partial information, which may depend on what has been learned in earlier stages of reporting. Ascending and descending multi-product auctions are dynamic mechanisms of this sort, which have been popular for commercial applications. These are typically applied when there are similar but distinct goods being sold, such as radio spectrum licenses to use different but nearby frequencies or commodities available at different locations or times, in different grades or with different amounts of processing, or subject to different delivery guarantees or contract terms. When goods are substitutes, modern simultaneous ascending or descending auctions—in which various goods are sold in auctions that take place simultaneously and are linked by so-called “activity rules”—are theoretically well-suited to finding stable allocations or competitive prices. During such auctions, bidders learn about market conditions before making their final bids, and that can improve the final allocation compared to the simplest sealed-bid mechanisms.

Dynamic auctions, however, have important drawbacks. The dynamic auctions that perform well according to economic theory require bidders to make very many bids as prices gradually change, leading to long, slow-running auctions that take many hours or sometimes days, weeks, or months to reach a conclusion. Such slow auctions are costly for participants and unworkable for spot markets, such as the hour-ahead markets for electricity, where only minutes are available to find clearing prices. For export applications, finding a convenient hour for real-time bidding by participants living in different time zones can be almost impossible. Moreover, because real auctions cannot use the infinitesimal price increments analyzed in theoretical models, actual dynamic auctions are essentially always inexact in finding market-clearing prices.

According to a theoretical result known as the revelation principle, it is possible to duplicate the outcome of any dynamic mechanism using a sealed-bid mechanism in which participants report preferences just once. The development of such an equivalent sealed-bid mechanism equivalent to the ascending or descending multi-product auction, however, has been blocked because suitably compact means of communicating preferences have not been developed. There are several problems with existing exchange communication structures.

One of the current problems with existing sealed-bid trading mechanisms, including exchanges and auctions, is that in their efforts to simplify the bidding process, only very simple bids may be entered and only simple rules applied, drastically limiting the ability of bids to communicate complex preferences. For certain types of transactions, more complex bids or rules may be valuable. A buyer who can meet its need in multiple ways and regards alternative lots as substitutes benefits from an ability to link bids so that it can make multiple bids and have only an adequate set of its bids filled.

A trader, who wishes to execute a “swap” transaction by buying one item and selling another, may find the transaction too risky unless it can link its bid-to-buy with its offer-to-sell, so that one is executed only if the other is executed as well. Prior art deals with this so-called “leg risk” by executing transactions in quick succession based on posted quotes, but this solution is limited by market liquidity and is not completely reliable.

Another problem with some current systems is that those that do allow complex bids—systems known as combinatorial auctions—determine only “package prices” and not market-clearing prices for individual items to clear markets. This is done because, in some exchange problems, market-clearing item prices do not exist. Still, individual item prices are required for many applications, for example to provide a basis for allocating sales revenue to multiple suppliers or where uniform prices are required by government regulations.

Yet another problem is that existing systems, especially for combinatorial bidding, rely on Boolean expressions to connect bids. Boolean expressions are not easily tailored to represent values of goods that are substitutes, and it can be difficult to determine whether a general Boolean expression represents substitution or is consistent with the existence of market clearing prices, as many applications require.

Certain multi-item sealed-bid auctions, including the “MaaX” design, are described in U.S. Patent Application Publication No. 2009/0177555 A1 and U.S. patent application Ser. No. 12/796,552 by Paul R. Milgrom, and other designs such as Day, Robert W. and Paul Milgrom (2008). “Core-Selecting Package Auctions.” International Journal of Game Theory 36(3-4): 393-407, and “Assignment Messages and Exchanges.” AEJ Micro 1(2): 95-113. Milgrom, Paul and Steve Goldband (2010). The entire contents of these applications are incorporated by reference herein. All of these sealed-bid auctions are ones in which bidders have a means to describe their maximum willingness to pay for various groups or packages of items.

The cited published analyses of these auctions assumes that bidders know the maximum prices they would be willing to pay to buy and the minimum prices they would accept to sell. In particular, any information learned during the auction or inferred from the outcome of the auction is assumed not to influence those maximum and minimum prices. Yet this assumption may not always be true. For example, in a forward auction, buyers could be uncertain about the prices that may prevail for similar goods in other marketplaces in the next day (or week or other time period). If those are markets in which the buyers might alternatively acquire the quantities they need, then any information about those future prices could be relevant to them. For example, in a forward auction, if the auction reveals the presence of a large quantity of additional demand just below the clearing price, that is a strong indicator that prices are more likely to rise than to fall in the near future. To the contrary, if the auction reveals that there is almost zero additional demand near the market-clearing prices, then any new supplies are likely to drive prices downward. Information about demand below but near-to market-clearing prices is therefore potentially very useful to bidders.

What is desirable are improved auction systems and methods for auctioning several types of products or several varieties of a single product simultaneously that incorporate both the advantages of a sealed-bid auction and some of the advantages of a multi-stage auction mechanism.

### SUMMARY OF THE INVENTION

The present invention overcomes the deficiencies of the prior art with systems and methods for conducting auctions for several types of products or several varieties of complex goods that allows bidders. By creating and implementing iterated sealed-bid auctions of several types of products or several varieties of a single product simultaneously, the present invention encourages select bidders to place more and higher bids. Sellers will therefore receive higher prices and products or services are more likely to be efficiently assigned. In general, iterated sealed-bid auctions are auctions in which bidders may make a variety of offers involving different prices and the final prices and allocation are determined according to the rules of a sealed-bid auction, but in which bidders may receive some feedback from initial rounds of bidding and have some opportunity to improve their price offers. In particular, the present invention promotes more efficient auction outcomes and, when overall competition is thin, higher revenues.

The present systems and methods provide greater benefits than multi-product clock auctions. Because they are a sequence of sealed-bid implementations, these auctions determine market-clearing outcomes for any target quantities faster and at lower costs than clock auctions, and are more accurate and offer fewer opportunities for collusion among bidders. And because they operate in two or more stages, they provide the information feedback benefits that are possible only in multi-stage auctions.

The single or multi-item iterated sealed-bid auction system that facilitates multiple rounds of sealed-bid auctions comprises a server, a network, a plurality of trader systems or a system to import bids, and one or more data store units. The trader systems are coupled by the network to the server. The server performs one or more rounds of a sealed-bid auction or exchange for one or more products or services, it receives or imports assignment messages or bid messages, creates report messages, provides feedback after each round to enable winning (or close to winning) bidders to improve their bids, and retrieves and stores data sets to and from the one or more data storage units. The assignment messages allow the users to include any budget constraints that apply to a plurality of bids on multiple items. The server comprises an interface module for receiving and sending messages and reporting results to bidders and administrators, a system for alternatively importing messages and exporting results, an auction module and/or an exchange module, and an allocation system. The allocation system determines an allocation of lots that maximizes a total money value for a plurality of bid groups subject to one or more constraints. The server also cooperates with the plurality of trader systems to present user interfaces for entering bids and bid groups, entering any constraints for the bids and bid groups, and showing the results of an auction or exchange, or with external systems to exchange information about the auction and receiving messages.

The present disclosure describes a computer-implemented method for determining a supply curve or demand curve for use in assigning, pricing, or exchanging multiple types of lots performed by one or more computing devices, wherein the method comprises the steps of 1) implementing an initial sealed-bid auction (round or stage) in which multiple bidders submit binding sealed-bids to buy, sell, or swap; 2) determining a provisional sealed-bid auction outcome; 3) generating an information feedback to bidders based on the initial sealed-bid auction; 4) determining a selection of bids from the initial sealed-bid auction for improvement because the selection of bids are determined to satisfy one of three criteria, including a) to be provisionally winning, b) to be close enough to be provisionally winning, and c) to be within range of a relevant threshold price for the auction; and 5) providing a subsequent sealed-bid auction in which bids from two groups are used, including a) sealed bids from the previous sealed-bid auction that were not improved and b) sealed bids from the previous sealed-bid auction that were improved.

The features and advantages described herein are not all-inclusive and many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The invention is illustrated by way of example, and not by way of limitation in the figures of the accompanying drawings in which like reference numerals are used to refer to similar elements.

FIGS. 1A and 1B are block diagrams of embodiments illustrating one example of the data structures and data of an assignment exchange and sealed-bid auction system.

FIG. 2 is a block diagram of one embodiment of an iterated sealed-bid auction system facilitating improved bids by bidders that are determined to be winners or close to winners.

FIG. 3A is a block diagram of a first embodiment of an allocation system.

FIG. 3B is a block diagram of a second embodiment of the allocation system.

FIGS. 4-13 are graphic representations of a first embodiment of example user interfaces generated by an assignment exchange and sealed-bid auction system.

FIG. 14 is a flow diagram of a method for implementing iterated sealed-bid auctions and processing bid groups in accordance with an embodiment of the present invention.

FIGS. 15-19 are graphic representations of a second embodiment of example user interfaces generated by an assignment exchange and sealed-bid auction system.

### DETAILED DESCRIPTION OF PREFERRED EMBODIMENTS

A system for implementing iterated sealed-bid auctions is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention. For example, the present invention is described in one embodiment below with reference to specific auctions. However, the present invention applies to any type of computing system and data processing for implementing an exchange or auction.

Reference in the specification to “one embodiment” or “an embodiment” means simply that a particular feature, structure, or characteristic described in connection with the embodiment is included in at least one embodiment of the invention. The appearances of the phrase “in one embodiment” in various places in the specification are not necessarily all referring to the same embodiment. In particular the present invention is described below in the context of two distinct architectures and some of the components are operable in both architectures while others are not.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Finally, the algorithms and displays presented herein are not inherently related to any particular computer or other apparatus. Various general-purpose systems may be used with programs in accordance with the teachings herein, or it may prove convenient to construct more specialized apparatuses to perform the required method steps. The required structure for a variety of these systems will appear from the description below. In addition, the present invention is described without reference to any particular programming language. It will be appreciated that a variety of programming languages may be used to implement the teachings of the invention as described herein.

### System Overview

The present invention operates as a direct mechanism that is compact, easy to implement, optionally respects integer constraints and is a “tight” simplification of a standard direct competitive mechanism. In one embodiment, the present invention also operates iteratively, in two or more stages (or rounds) to allow final reports and outcomes to be informed by earlier reported information or by summary reports and outcomes based on that information. The systems and methods may establish connections between the assignment auction and exchange and the Vickrey auction and exchange, the uniform price auction and exchange for a single type of product, and an ascending or descending multi-product clock auction.

The present invention, called an “assignment exchange and iterated sealed-bid auction” system, is a mechanism for use in assigning and pricing multiple goods or products or varieties of a good or product. While the present invention is described below in the context of goods, those skilled in the art will recognize that the system and method of the present invention can be used for services or any other exchangeable item. Simplification is at the core of much of practical market design. In many real applications, the direct mechanisms studied in much of economic theory are far too complex to be useful. The “assignment exchange and iterated sealed-bid auction” system applies to settings in which there are a certain number of varieties of a good (for example, including but not limited to electric power) that are offered for sale.

The assignment exchange and iterated sealed-bid auction system of the present invention is particularly advantageous because it provides a mechanism that accommodates substitution of and among goods or lots. When different versions of a good are substitutable at all for a particular user, the rate of substitution is frequently one-for-one, or nearly so. For example, a cement purchaser may wish to buy some quantity of cement and may be prepared to pay more to a supplier located closer to the point of use, but the number of tons needed may still be fixed independently of the source: substitution is one-for-one.

A northern California electric utility may purchase power at the Oregon border or from southern California, subject to transmission constraints on each. Or, a cereal maker may be able to substitute bushels of grain today for bushels tomorrow by storing the grain in a suitable facility or one type of grain for another up to limits imposed by product specifications. These are all examples of substitution by buyers, but a similar structure is found among sellers, as when a manufacturer can deliver several versions of the same processed good. In each case, substitution possibilities are typically limited, but when substitution is possible at all, it involves at least approximately one-for-one substitution among various versions of a good. This property of one-for-one substitution, combined with integer demands and/or supplies, ensures that there exists an efficient solution with integer allocations. The assignment exchange and iterated sealed-bid auction system of the present invention takes advantage of the one-for-one substitution possibility whenever that is available and outputs integer allocations. This is an important property. Many commodities are most efficiently shipped by the truckload or container-load, and even divisible resources such as electrical power may be sold in whole numbers of megawatts. Even when integer constraints are not logically necessary, common practice may make them useful: a practical resource allocation mechanism must be able to respect such integer constraints.

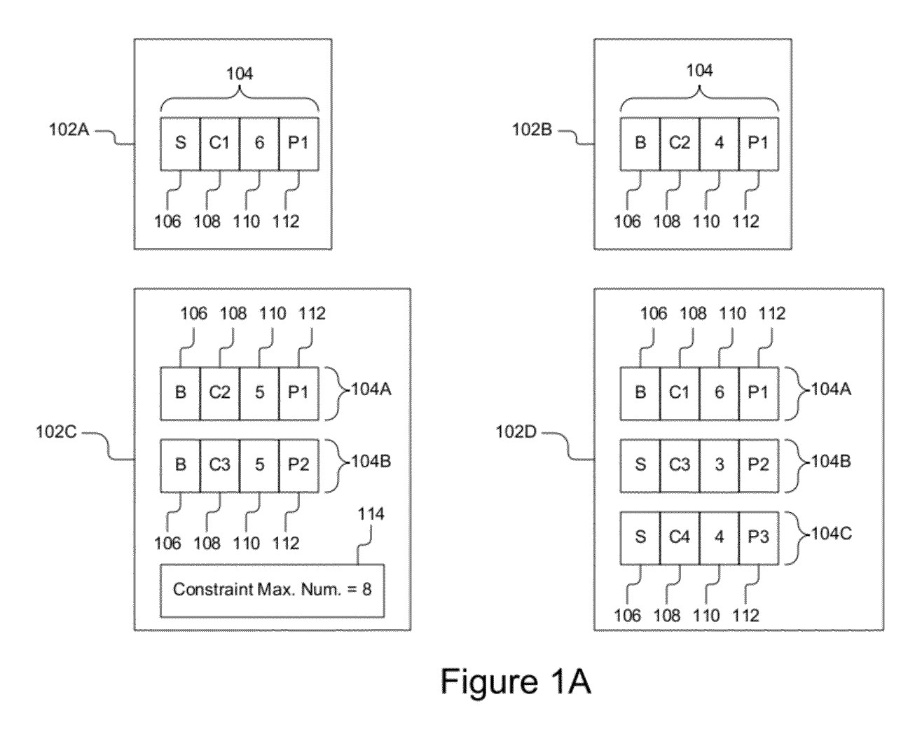

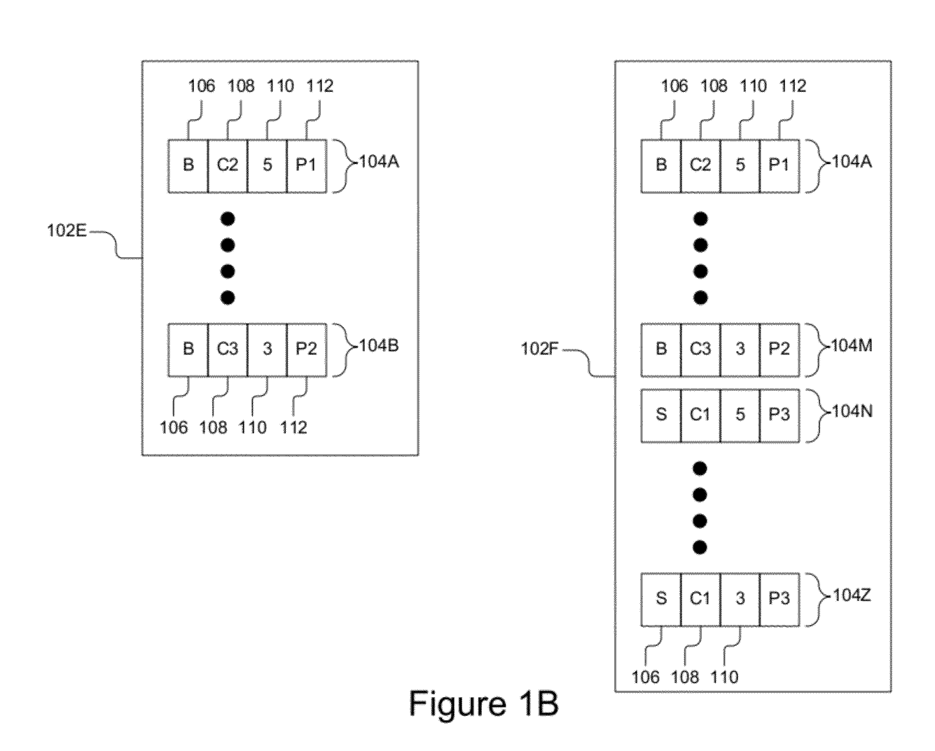

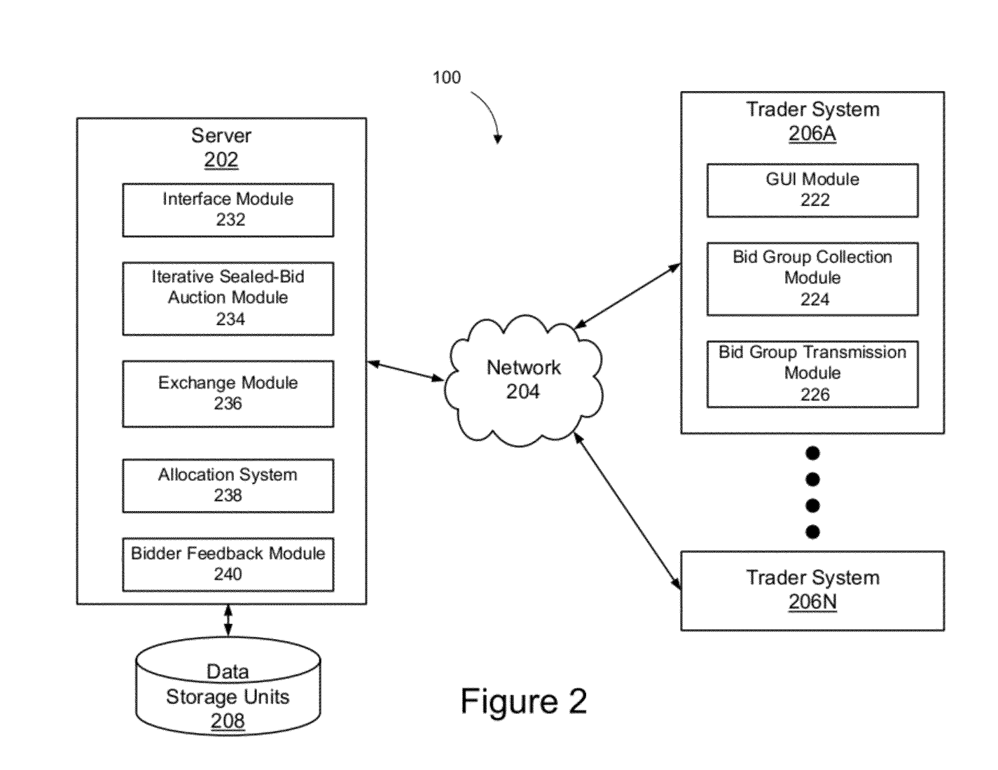

FIGS. 1A and 1B show one embodiment of example data structures and data for an assignment exchange and iterated sealed-bid auction system 100 (See FIG. 2). In this example, one or more sellers are offering or one or more buyers are bidding on three substitute lots, more particularly, commodities C1, C2, and C3. Throughout the description below of the present invention, the term “lot” will be used to denote the unit being exchanged or purchased or priced. Those skilled in the art will recognize that a lot may be an item, a good, a service, a good and a service, a product, a collection of goods, a collection of services, a collection of goods and a collection of services, or any other combinations of the previous. The system 100 operates on two or more bid groups 102A-102F. A bid group 102A-102F includes one or more bids 104. In one embodiment, the bid group 102A-102F also includes a constraint, such as a maximum total number of lots for the bid group 102A-102F. A bid 104 includes a first field 106 for indicating or specifying whether the bid is to sell or to buy, a second field 108 for specifying a type of lot, a third field 110 specifying a maximum number of lots of the type specified in the second field 108, and a fourth field 112 specifying a money value per lot. FIGS. 1A and 1B show seven example bid groups 102A-102F demonstrating the different types of bid 104 that may be included within a bid group 102A-102F.

A first embodiment of a bid group 102A shows the simplest configuration for a bid group 102A-102F. The first embodiment of the bid group 102A has a single bid 104. The single bid 104 has the structure described above and includes the first through fourth fields 106, 108, 110 and 112. For example, the bid 104 is a bid to sell six lots of commodity C1 at price P1. The first embodiment of the bid group 102A illustrates that a bid group can include only a single bid to sell.

A second embodiment of a bid group 102B shows another simple configuration for a bid group 102A-102F. A second embodiment of the bid group 102B again has a single bid 104. The single bid 104 has the structure described above and includes the first through fourth fields 106, 108, 110 and 112. For example, the bid 104 is a bid to buy four lots of commodity C2 at price P1. The second embodiment of the bid group 102B illustrates that a big group can include only a single bid to buy.

A third embodiment of a bid group 102C shows another configuration for a bid group in which there are a plurality of bids 104A, 104B that are subject to a total effective quantity constraint 114. Again, each of the plurality of bids 104A, 104B has the structure described above and includes the first through fourth fields 106, 108, 110 and 112. For example, a first bid 104A of the bid group 102C is a bid to buy five lots of commodity C1 at price P1 and the second in 104B of the bid group 102C is a bid to buy five lots of commodity C3 at price P2. Both of these bids 104A, 104B are subject to constraint 114 that specifies that the total number of units may not exceed eight. In other words, the constraint 114 implements a mutually exclusive such that the maximum number of lots of C2 and C3 is at most eight (8=5+5−2). Those skilled in the art will recognize that while only two bids to buy 104A, 104B are shown in bid group 102C, other configurations of bid groups could apply a mutually exclusive or constraint to bids to sell, or a combination of bids to buy and sell including any number of bids to sell and buy. In some cases, the first field could be eliminated and the bids 104 expressed as a vector, essentially in the same format as a bid, but with negative quantities expressing an offer for sale rather than an offer to buy. In some cases, the same commodity may appear in multiple bids in a single group, thereby to describe a single-product supply function or a single-product demand function.

A fourth embodiment a bid group 102D shows that the bid group 102D can include a plurality of bids 104A, 104B and 104C that implement a swap. In other words, the plurality of bids 104A, 104B and 104C need not be of the same type (all bids to buy or all bids to sell), and in fact, at least one of the bids in a swap bid group must be a bid to sell and a second of the bids must be a bid to buy. Again, each of the plurality of bids 104A, 104B and 104C has the structure described above and includes the first through fourth fields 106, 108, 110 and 112. For example, a first bid 104A of the bid group 102D is a bid to buy six lots of commodity C1 at price P1; the second bid 104B of the bid group 102D is a bid to sell three lots of commodity C3 at price P2; and the third bid 104C of the bid group 102D is a bid to sell four lots of commodity C4 at price P3. While the example bid group 102D only shows a single bid 104A to buy, those skilled in the art will recognize that bid group 102D is swap and can include a plurality of bids to sell and a plurality of bids to buy.

Referring now to FIG. 1B, a fifth embodiment a bid group 102E shows that the bid group 102E includes a plurality of bids 104A-104N. This embodiment is similar to that of bid group 102A, except that there are a plurality of bids 104A-104N to buy. Each of the plurality of bids 104A-104N has the structure described above and includes the first through fourth fields 106, 108, 110 and 112. While bid group 102E shows the bids as being bids to buy, those skilled in the art will recognize that they could alternatively be bids to sell.

A sixth embodiment a bid group 102F shows that the bid group 102F as including a plurality of bids 104A-104M, 104N-104Z. Each of the plurality of bids 104A-104M, 104N-104Z has the structure described above and includes the first through fourth fields 106, 108, 110 and 112. In this embodiment, however, the bid group 102F includes both a plurality of bids 104A-104M to buy and a plurality of bids 104A-104M to sell. It should be noted that each of the bids 104A-104M, 104N-104Z can also specify a different commodity, a different number of lots, and a different price.

FIG. 2 illustrates one embodiment of the assignment exchange and iterated sealed-bid auction system 100 according to the present invention. The assignment exchange and iterated sealed-bid auction system 100 comprises a server 202, a network 204, a plurality of trader systems 206A-206N and one or more data store units illustrated together at 208. The trader systems 206A-206N are connected via the network 204 to the server 202.

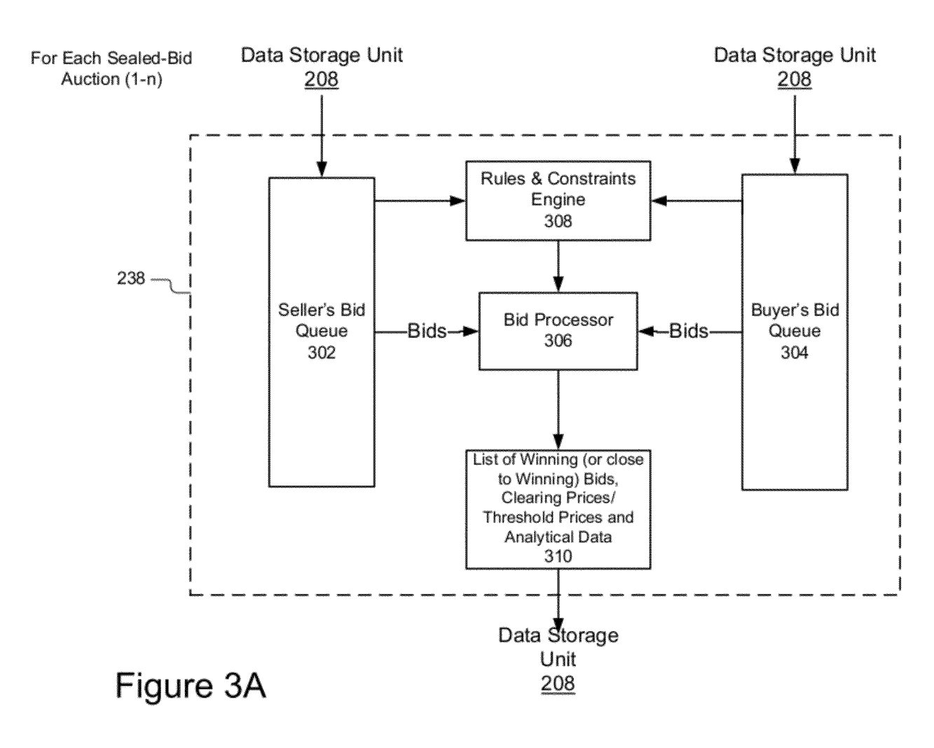

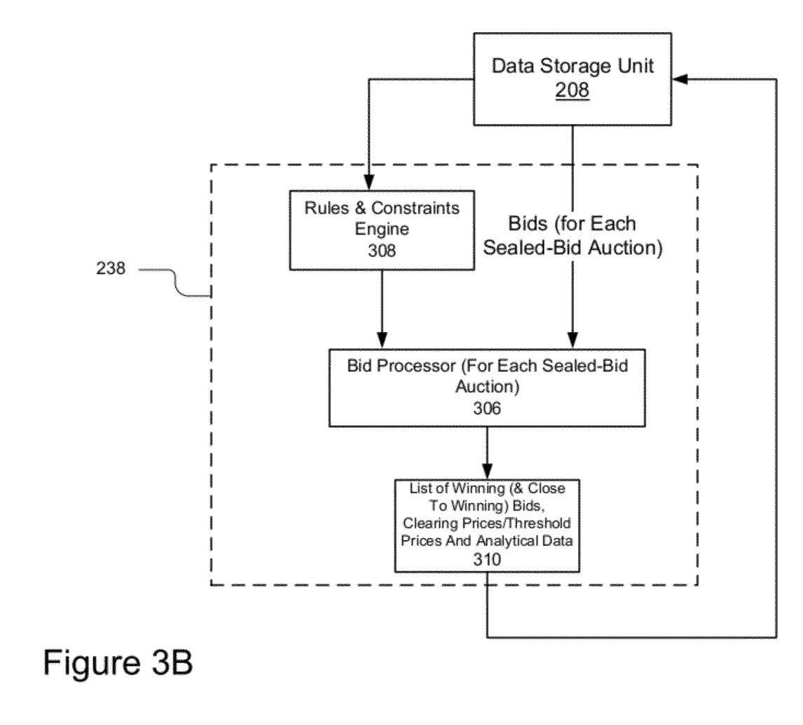

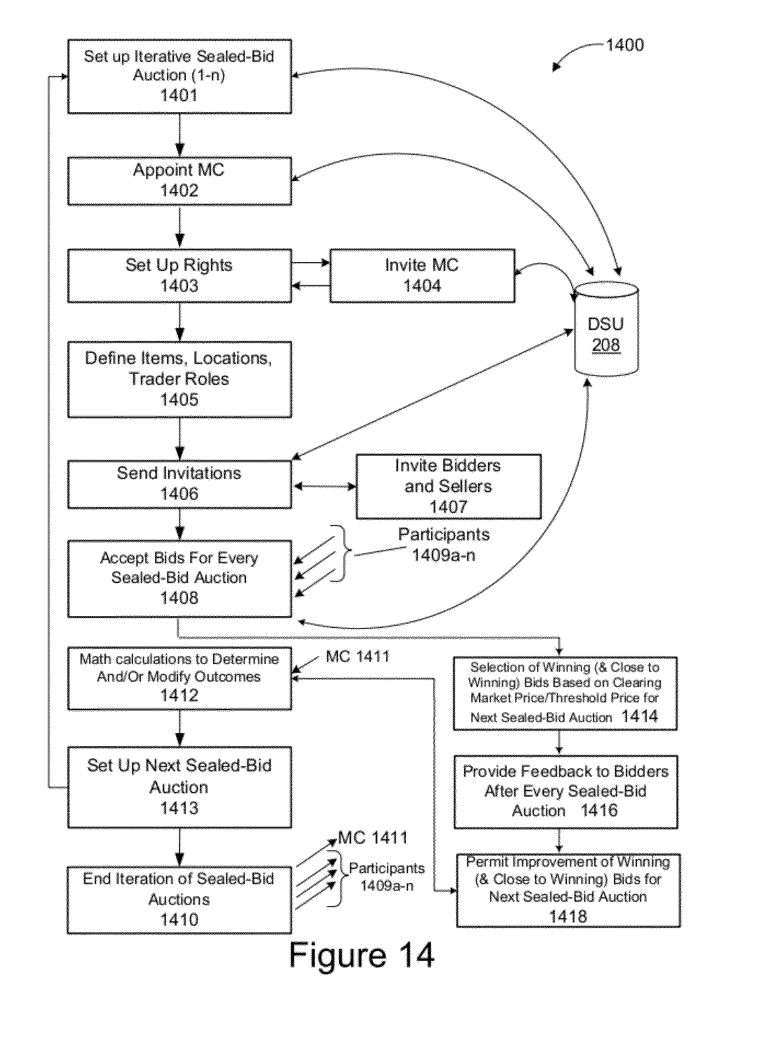

The server 202 is a conventional computer including a processor, memory, non-volatile storage, and a network connection. The server 202 may optionally include one or more input devices and one or more output devices. The server 202 is an apparatus for performing a sealed-bid auction or exchange, for receiving assignment messages, creating and sending reporting messages, for retrieving and storing data sets to and from the data storage unit 208. The server 202 is coupled for communication and interaction with the plurality of trader systems 206A-206N via the network 204. The server 202 is also coupled for communication and interaction with the one or more data storage unit 208. The server 202 is hardware capable of executing and performing routines to achieve the functionality described below with reference to FIGS. 3 and 14. The server 202 comprises an interface module 232, an illustrative sealed-bid auction module 234, an exchange module 236, an allocation system 238, and a bidder feedback module 240.

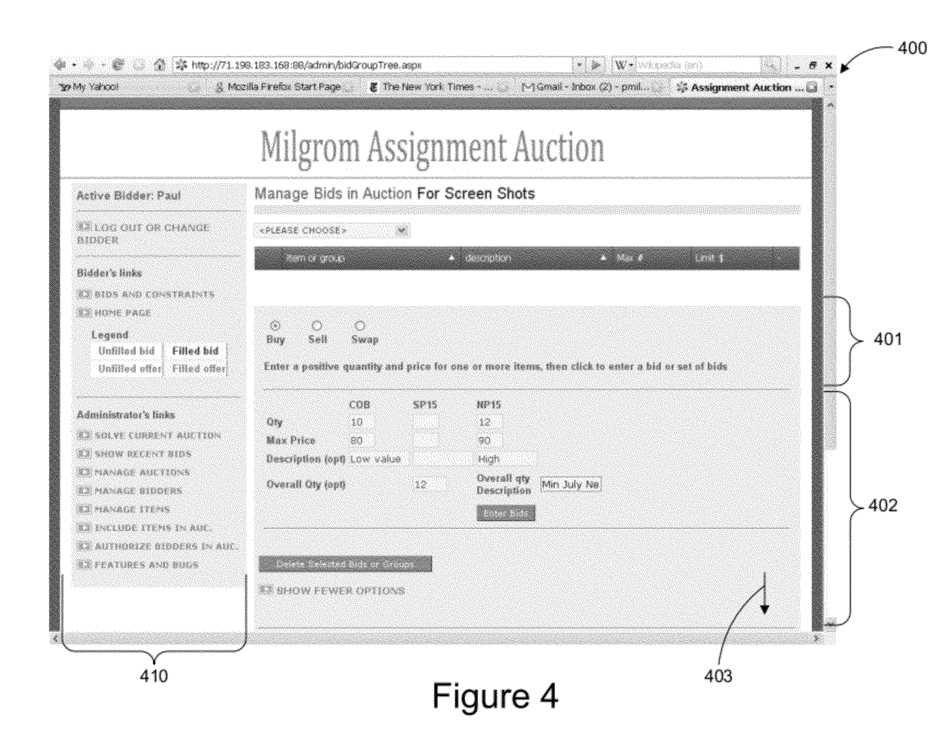

The interface module 232 is software and routines executable on the server 202 to create the user interfaces depicted below by way of example in FIGS. 4-13 and 15-19. The interface module 232 also controls and handles the communication between the server 202 and the plurality of trader systems 206A-206N. The interface module 232 also controls the exchange of data between the one or more data storage unit 208, the iterated sealed-bid auction module 234, the exchange module 236, the allocation system 238, and the bidder feedback module 240. In one embodiment, the interface module 234 is responsible for receiving assignment messages and translating them into a data format usable by the other components of the server 202. The interface module 234 is also responsible for creating and sending reporting messages to the plurality of trader systems 206A-206N.

The iterated sealed-bid auction module 234 is software and routines executable on the server 202 to operate and run one or more sealed-bid auctions iteratively. In one embodiment, the iterated sealed-bid auction module 234 is adapted for interaction and communication with the interface module 232 and the allocation system 238 during the operation of the auction. The iterated sealed-bid auction module 234 controls the receipt of bid groups and cooperates with the allocation system 238 to determine a winning bid group and close to winning bid group and send out notification messages. The iterated sealed-bid auction module 234 also cooperates with the interface module 232 to receive and store data sets relating to the auction to and from the data storage unit 208.

The exchange module 236 is software and routines executable on the server 202 to operate and run an exchange. In one embodiment, the exchange module 236 is adapted for communication and interaction with the interface module 232 and the allocation system 238 for operation of the exchange. The exchange module 236 controls the receipt of bid groups and cooperates with the allocation system 238 to determine a list of winning bid groups and close to winning bid groups and send notification messages to the trader systems 26A-206N. The exchange module 236 also cooperates with the interface module 232 to receive and store data sets relating to the exchange to and from the data storage unit 208.

The allocation system 238 is software and routines executable on the server 202 to determine an allocation of lots that maximizes a total money value for a plurality of bid groups subject to one or more constraints. As noted above, the allocation system 238 cooperates with the iterated sealed-bid auction module 234 and/or the exchange module to create a sealed-bid auction or exchange, respectively. The operation and components of the allocation system 238 are described below in more detail with reference to FIG. 3. The allocation system 238 interacts with the data storage unit 208 via the interface module 232.

The network 204 is of a conventional type such as the internet for interconnecting computing devices. The network 204 can be any one of a conventional type such as a local area network (LAN), a wide area network (WAN) or any other interconnected data path across which multiple computing devices may communicate.

Each of the trader systems 206A-206 is one or more computing systems such as a personal computer and includes a graphical user interface module 222, a bid group collection module 224 and a bid group transmission module 224. In one embodiment, the graphical user interface module 222, the bid group collection module 224 and the bid group transmission module 224 are software operable on a general purpose computer. In another embodiment, the graphical user interface module 222, the bid group collection module 224 and the bid group transmission module 224 are specialized hardware for providing functionality described below and with reference to the user interfaces of FIGS. 4-13.

In one embodiment, the graphical user interface (GMI) module 222 is software and a set of routines executable by the trader system 206A to provide the graphical user interfaces shown in FIGS. 4-13 and 15-19 by way of some examples. For example, the graphical user interface (GMI) module 222 includes a conventional type browser such as Internet Explorer from Microsoft Corporation or Firefox from the Mozilla Foundation. The graphical user-interface module 222 also presents the user interfaces as described below. The graphic-user interface module 222 interacts, cooperates, and communicates with the bid collection module 224 and the bid group transmission module 226.

The bid group collection module 224 is software and a set of routines executable by the trader system 206A to collect information related to bid groups. The information collected by the bid group collection module 224 include the actual information used to formulate bids and bid groups, control and administrative information for the presentation of data, user accounts, auctions, exchanges, etc. The bid group collection module 224 is adapted for communication with the graphical user interface module 222 and the bid group transmission module 226.

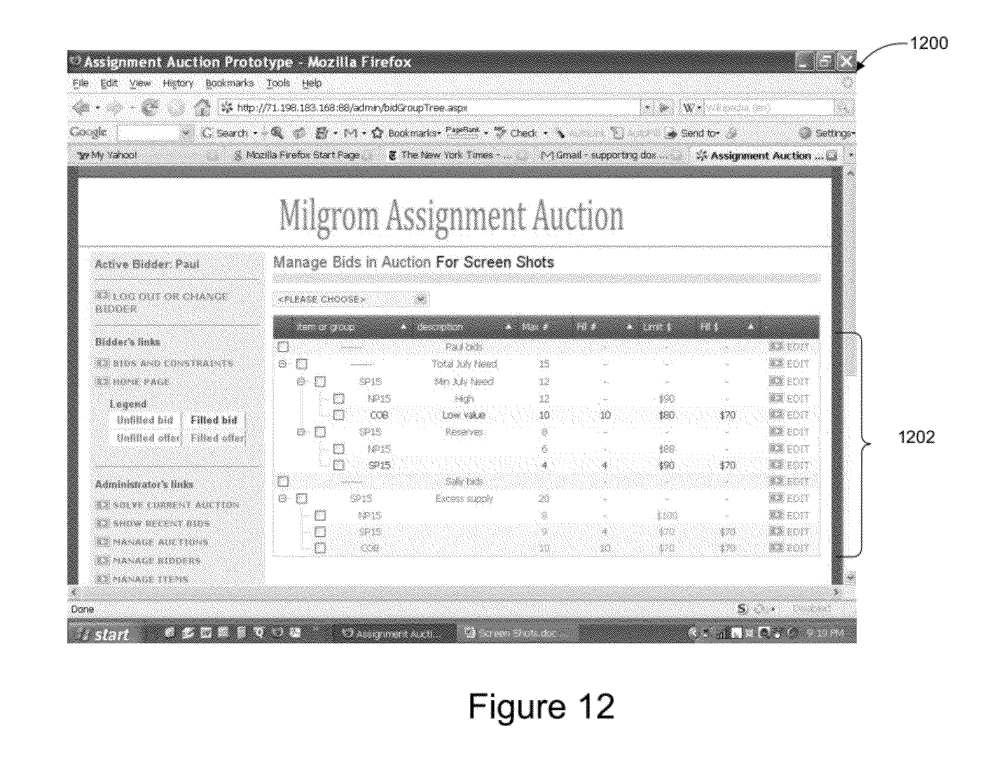

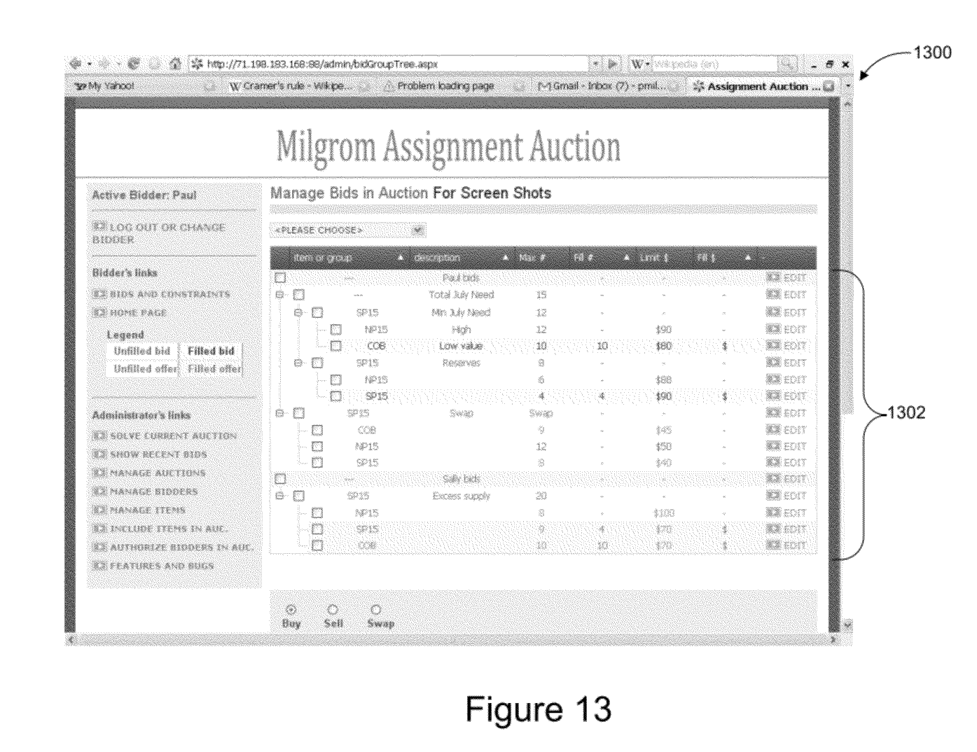

The bid group transmission module 226 is software and routines executable by the trader system 206A to send bids and bid group information to the server 202. In one embodiment, the bids and bid group information are sent to the server 202 as assignment messages. The bid group transmission module 226 take the information generated by the bid group collection module 224 and transmits it to the server 202. In one embodiment, the bid group transmission module 226 is responsible for establishing a secure communication link with the server 202. The bid group transmission module 226 also receives report messages from the server 202. The report messages include data that is presented to the user in some of the interfaces such as those shown in FIGS. 12 and 13. The bid group transmission module 226 provides the information to the graphical user interface module 222 which is presents the information to the user. The bid group transmission module 226 is adapted for communication with the bid group collection module 224 and the server 202.

The data storage unit 208 is a device such as a hard disk drive or other storage media. The data storage unit 208 is shown as being coupled to the server 202. The data storage unit 208 is used to store data sets including bid groups, bids and other information necessary for the execution of a sealed-bid auction or an exchange.

### Allocation System

FIG. 3A shows a one embodiment of the allocation system 238. The allocation system 238 comprises a seller's bid queue 302, a buyer's bid queue 304, a bid processor 306, a rules and constraints engine 308, and storage 310 for a list of winning (or close to winning) bids and other information such as clearing prices, threshold prices computed by the auctioneer for each bid. The traders' bid groups, including both bids to buy and offers to sell, are collected as data sets and stored in the data storage unit 208, along with other possible restrictions such as minimal lot sizes, limits on the quantity assigned to groups of bids, maximum allocation per buyer, etc. The allocation system 238 accesses the data storage unit 208 and retrieves the bid groups that have been received from the plurality of trader systems 206A-206N. The retrieved bids to sell are stored in the seller's bid queue 302 and any rules or constrained information related to bids to sell are output by the seller's bid queue 302 to the rules and constraints engine 308. The bids to sell stored in the seller's bid queue 302 are also accessible by the bid processor 306. Similarly, the allocation system 238 stores retrieved bids to buy in the buyer's bid queue 304, provides any rules or constrained information related to the bids to buy from the buyer's bid queue 304 to the rules and constraints engine 308 and makes the bids to buy accessible by the bid processor 306.

The allocation system 238 then uses rules and constraints engine 308 to process the bids from the sellers bid queue 302 and buyers bid queue 304 to determine rules and constraints to determine the allocation of lots and the market-clearing prices in a sealed-bid auction or exchange. These rules and constraints are output from the rules and constraints engine 308 to the bid processor 306. The bid processor 306 then processes the rules and constraints, the bids in the sellers bid queue 302 and the buyers bid queue 302 to generate a list of winning bids, if any, clearing prices and analytical data. The bid processor 306 stores those bids, the clearing prices and other analytical data in storage 310. Part of the resolution is substitution of similar commodities (C1, C2 and C3 in this example) matching the bid vectors and, if any, external rules and constraints (for example, limits on the quantities assigned to groups of bids). That allows for allocation of resources at a market-clearing price, hence an efficient allocation of resources.

FIG. 3B shows another embodiment of the allocation system 238. This second embodiment of the allocation system 238 comprises the bid processor 306, the rules and constraints engine 308 and storage 310. The traders' bid groups, including both bids to buy and offers to sell, are collected as data sets and stored in the data storage unit 208, along with other possible restrictions such as minimal lot sizes, limits on the quantity assigned to groups of bids, maximum allocation per buyer, etc. The allocation system 238 accesses the data storage unit 208 and retrieves the bid groups that have been received from the plurality of trader systems 206A-206N. The traders' bid groups are retrieved from the data storage unit 208 by the rules and constraints engine 308 and the bid processor 306.

The rules and constraints engine 308 processes the bids from the data storage unit 208 to determine rules and constraints. These rules and constraints are output from the rules and constraints engine 308 to the bid processor 306. The bid processor 306 processes the rules and constraints, and the bids from the data storage unit 208 to determine the allocation of lots and the market-clearing prices in an auction or exchange. The bid processor 306 then generates a list of winning bids, if any, clearing prices and analytical data. The bid processor 306 stores those bids, the clearing prices and the analytical data in storage 310. This information can also be stored in the data storage unit 208 for use by the auction module 234, the exchange module 236 or the interface module 232. While the above description presents the allocation process as sequential, those skilled in the art will recognize that in other embodiments, the allocation can be determined all at once where the bids are transmitted to the allocation system 238 which then runs a solver on the bid processor 306 that computes the allocation and prices.

Prior to a sealed-bid auction, in some cases, the auctioneer may publish guidelines, results of prior auctions or exchange events, and some bids for informational purposes. Depending on the published information, traders may have multiple bids. For example, a buyer may have multiple bids with each representing the needs of a particular factory. The exchange module 236 awards quantities as the solution of a particular linear program, which maximizes the difference between the total money values of the awarded bids to buy minus the total money value of the awarded offers to sell. The linear program is described in the attached Appendix A. If there are multiple allocations that achieve the maximum in the linear program, the exchange module 236 resolves among those using a quantity-tie-breaking rule. The exchange module 236 also determines prices for each product by solving the dual linear program, also described in Appendix A. The resulting prices are market-clearing prices. If there are multiple solutions to the dual linear program, then the exchange resolves among those using a price-tie-breaking-rule. For example, if the exchange operates as an auction with a single seller and multiple buyers, according to a preferred mode of the present invention discussed in detail in Appendix A, the lowest market-clearing price for each commodity may be determined. The various items sold may have different prices to reflect various differences. For example, the difference may be the product grade, such as coffee beans that differ in origin, size, and color, or it may be the location of delivery, which affects the costs of transporting the product to its place of use, or it may reflect the time of availability or contract terms or degree of processing, etc.

It is clear that many modifications and variations of this embodiment may be made by one skilled in the art without departing from the spirit of the novel art of this disclosure. For example, depending on the auction, who holds the auction, and who takes the bids to buy and sell, different rules may be published and hence used in a rules-and-constraints engine to resolve those bids. These modifications and variations do not depart from the broader spirit and scope of the invention, and the examples cited here are to be regarded in an illustrative rather than a restrictive sense. The approach described here can be used both online and, in simple cases, offline. Also, sellers might be limited to a single offer, or, in more commoditized situations, many bids, sometimes in regular time intervals, sometimes as a one time or occasional auction.

The advantages of the current invention are that maximum value relative to the bids is always achieved, market-clearing item prices are determined, prices properly reflect relevant differences in cost and value to the traders (including buyers, sellers, and swappers), integer solutions supported by market-clearing prices can be guaranteed, and bidding is quick and easy.

### User Interfaces

In the assignment exchange and iterated sealed-bid auction system 100 as described earlier in FIGS. 2 and 3, one of the important aspects is assignment messaging and how to enter necessary auction restrictions or combinations, typically in the form of rules.

FIG. 4 shows a graphic representation of a first embodiment of a user interface 400 generated by the assignment exchange and auction system 100. The user interface 400 (depicted as a screen shot of a simulation) is a window that allows a user to enter auction rules and thereby form restrictions on his bids or offers. On the left side of the user interface 400 is a section 410 with elements that forms a dashboard-type window where the user can view important data such as, for example, parameters, listings, and participants. Depending on the participant's role or roles (administrator, buyer, seller, etc.), some of the elements shown in sections 401 and 410 are excluded from the user interface 400. On the right side is the transaction window, comprising area 401 with elements and area 402 with elements. Arrow 403 (which typically is not part of the user interface 400, but is added into the FIG. 4 to help the reader of this document understand that FIG. 4 only shows a portion of the user interface 400) indicates that area 402 continues below the visible portion of the window and is accessed by scrolling in the window, using means that are customary in such applications. Area 401 is an area for the user to select the type of transaction or bid for entry into the system 100 and presents a plurality of labels and corresponding radio buttons. The user may select Buy (that is, a bid to buy) Sell, or Swap—the Swaps shown are combinations of bids to buy and offers to sell in which the total quantities bought and sold are required to be equal. For a bidder who is eligible only to buy or only to sell, section 401 is omitted from the interface. In this example, a user who is eligible to buy, sell or swap is entering a bid to buy. Area 402 presents a plurality of text boxes or fields for the user to input the types of lots that are the subject of this example bid (for commodities, a preferred but not exclusive use of assignment auctions). In this example, what is being traded is energy in the form of electricity delivered at three different locations, labeled COB, SP15 and NP15. On the top of area 402, going across, are the delivery points COB, SP15, and NP15, with associated fields for bid quantities entered by the user listed just below. In this example, the user has input at COB the quantity to be bought is 10 and at NP15 the quantity is 12 into the user interface 400. The maximum price associated with each lot at NP 15 is higher, because the hypothetical buyer is located in Northern California and the transmission cost from COB (California-Oregon border) reduces the value of energy delivered there. The user interface 400 also enables the user to describe a bid group constraint. In this example, the constraint limits the overall quantity input for this group to 12, which indicates that with this group, the user does not offer to buy more than 12 units of power in total. For example, if the group is assigned 12 units of power at NP15, then it must not be assigned any power at COB. Given the computed market clearing prices, the allocation determined by the system 100 respects bidders' reported preferences. For example, suppose that the bids made by this user both exceed the computed market clearing prices. If the excess is greater for NP15 than for COB, then the buyer will be awarded twelve units of power at NP15. If, instead, the excess is greater for COB than for NP15, then the buyer will be awarded its maximum quantity of 10 at COB and 2 more units at NP15, so the total assigned quantity is 12.

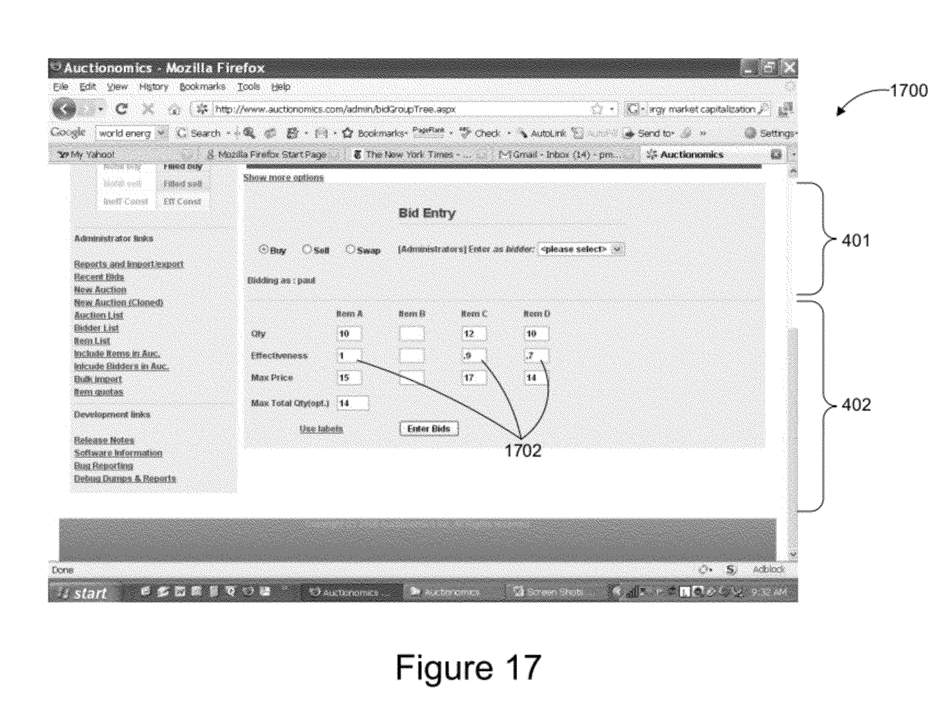

The decision of which types of items to offer and which traders to invite are determined by custom or by the auctioneer based on consultation with important traders. In some cases, traders may run their own auction, to buy, sell or swap products. FIG. 17 shows a second embodiment for the user interface 1700 for entering bids. The second embodiment of the user interface 1700 is similar to user interface 400, but it also provides fields 1702 for receiving an effectiveness value, the role of which is discussed in Appendix A.

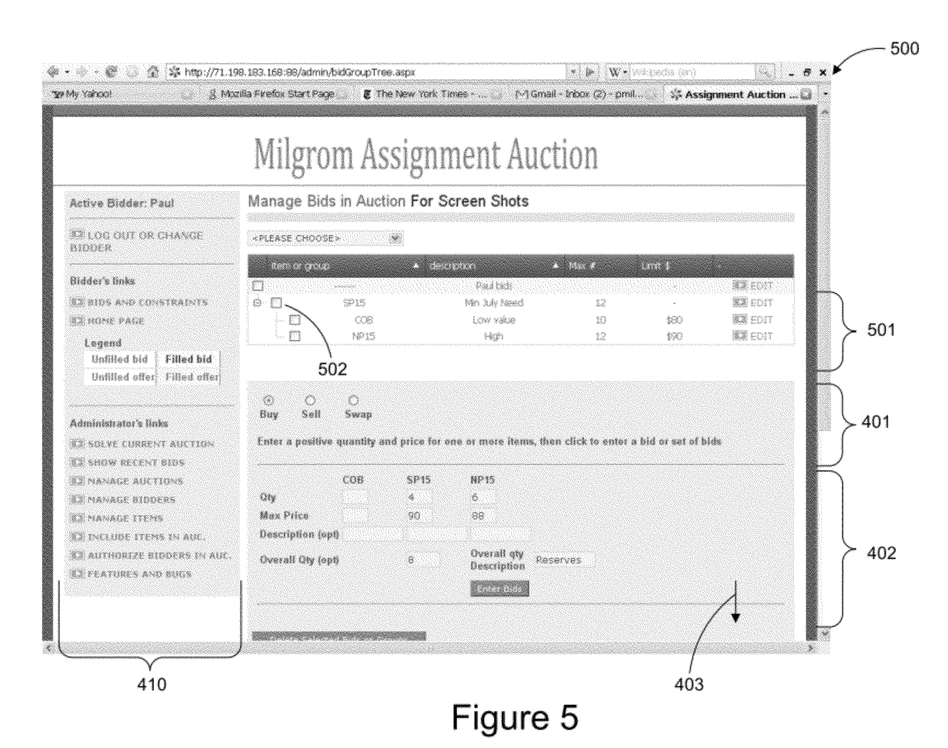

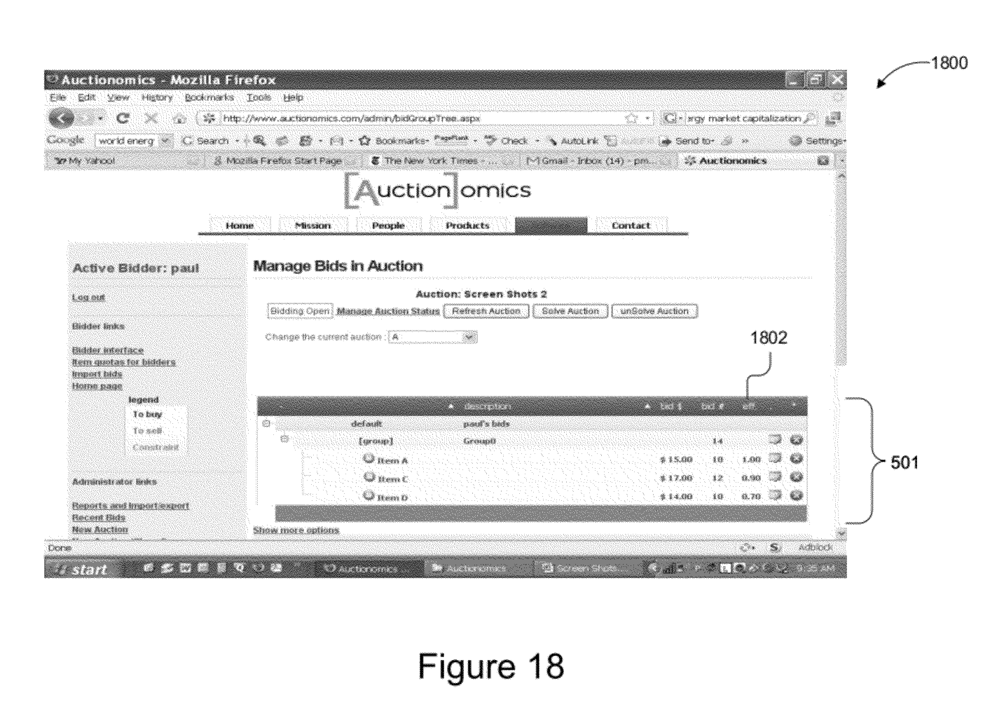

FIG. 5 shows a second embodiment of the user interface 500 after the transaction of FIG. 4 has been entered into the system 100. Section 501 shows the bid group 502 with the 2 bids input in FIG. 4 as tree constraints. Areas 401 and 402 with the same functionality as described above are part of interface 500 to allow the user to enter additional bids. In the example user interface 500, the user has added additional bids in area 402: A first bid for four lots of SP15 at a price of 90 and a second bid for six lots of NP15 at a price of 88. FIG. 18 shows a second embodiment for the user interface 1800 after bids have been entered. The second embodiment of the user interface 1800 is similar to user interface 500, but it also provides a column 1802 for presenting the effectiveness value associated with a bid. When the system does not include a field for bidders to specify the effectiveness value, that value is set to a default determined by the system. Appendix A describes cases in which the logical default value is one.

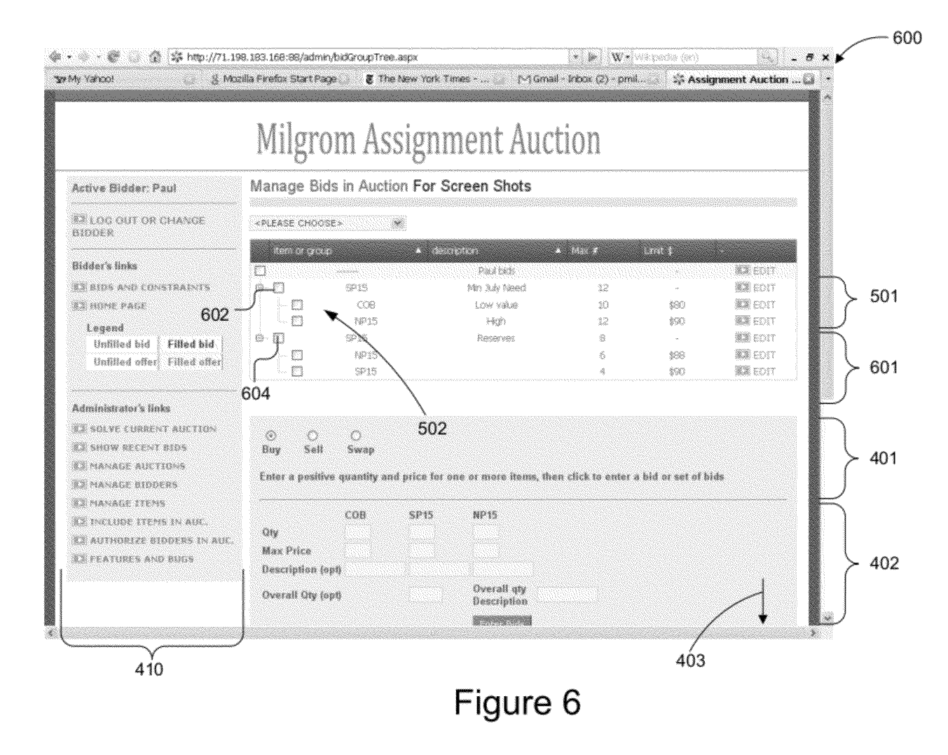

FIG. 6 shows a third embodiment of the user interface 600 after the user has selected the enter button of area 402 in FIG. 5. In response, the system 100 generates and presents the third embodiment of the interface 600. The third embodiment of the interface 600 expands section 501 to add portion 601. Together section 501 portion 601 showed the expanded tree 502 with the first bid group 602 entered using the first embodiment of user interface 400 and the second bid group 604 entered using the second embodiment of the user interface 500.

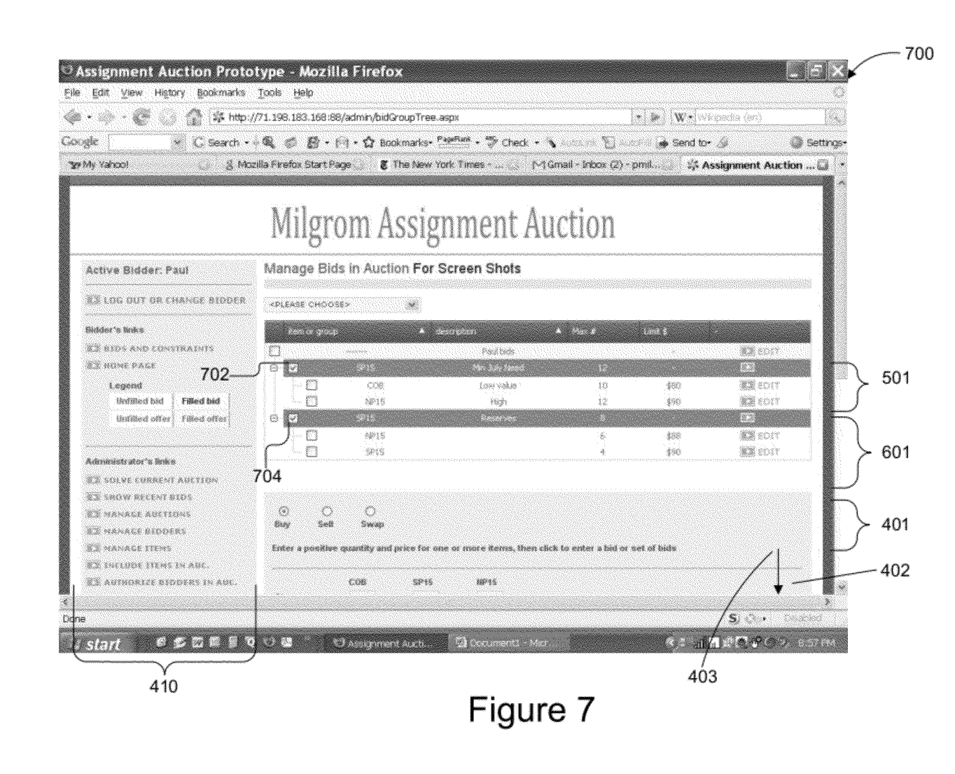

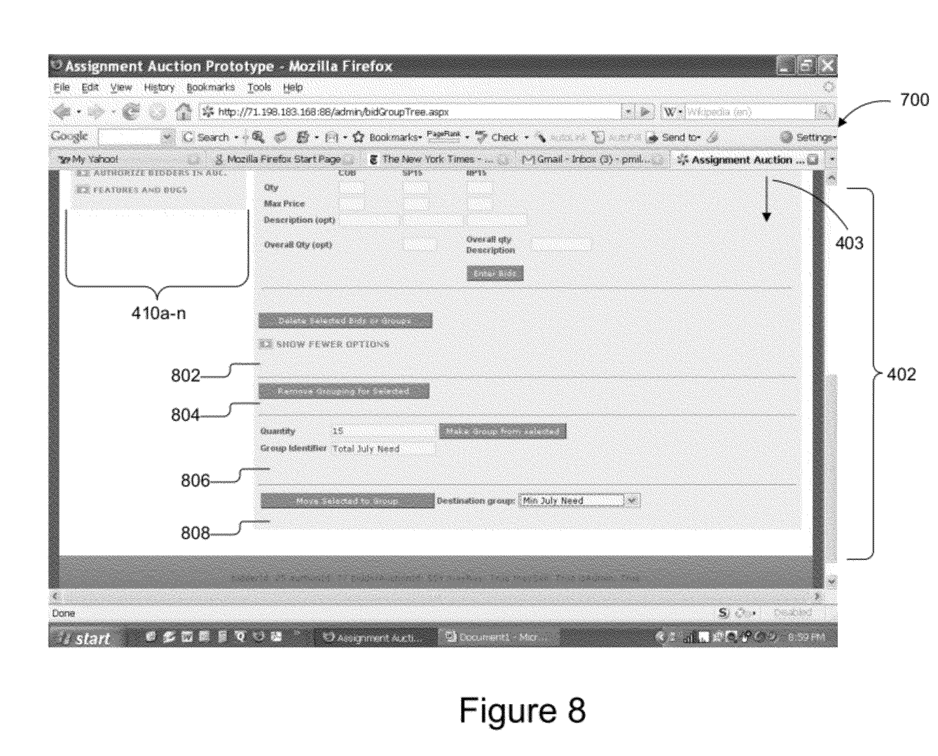

FIGS. 7 and 8 show a graphical representation of another embodiment of the user interface 700 in which the user (a buyer in this example) has clicked on selection buttons 702, 704 in sections 501 and 601, highlighting those two bids, to edit them and link them using an overall rule (for example, limiting total quantity of both bids, thus turning them into subrogated subsets of an overall bid). FIG. 8 shows a graphical representation of user interface 700 scrolled down to the portion that arrow 403 indicated in FIG. 7. Area 402 includes additional subsections 802, 804, 806 and 808 for manipulating the bid groups and bids and other characteristics of the bid groups and bids. For example, subsection 802 includes buttons to delete a bid group or bid as well as modify other options associated with the bids. The user selects the bid or group using the upper part of user interface 700 shown in FIG. 7 and the uses subsection 802 of user interface 700 shown in FIG. 8 to specify a delete action. Similarly, subsection 804 of user interface 700 shown in FIG. 8 is used to specify a remove grouping action. Subsection 806 defines an area for the user to create groups and add a constraint. For the example shown, the fields and buttons presented in subsection 806 set a constraint that the total quantity assigned to the two bid groups 702 and 704 is 15 and that the two bid groups 702 and 704 are a single bid group with that constraint. Finally, subsection 808 of user interface 700 shown in FIG. 8 is used to specify a action of moving a group and the group into which it is moved. This allows the user to effectively move branches of the tree as desired.

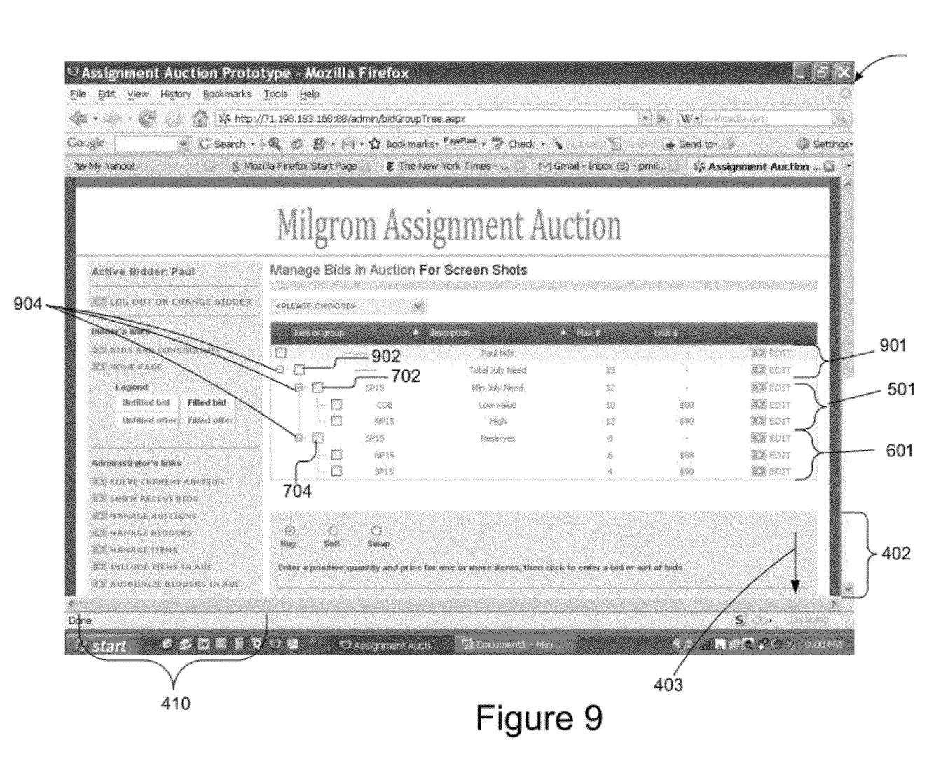

FIG. 9 shows an embodiment of the user interface 900 after the user has selected the “Make Group From Selected” button of area 804 in FIG. 5. Selection of this button combines bid groups 702 and 704 into a new bid group 902. This embodiment of the user interface 900 shows an additional area 901 in addition to section 501 and portion 601. The additional area 901 is used for presenting the new bid group 902. The additional area 901, addition to section 501 and portion 601 organize the bid groups as a hierarchical tree structure. Now the two bid groups 702 and 704 are linked on a branch of the tree showing a total of 15 units in area 901 and the two separate subrogated bids of 12 units in bid groups 702 and 8 units in bid groups 704. The plus or minus signs in selector boxes 904 are used to expand or collapse the display of parts of the tree, as is common in web-based user interfaces with hierarchical structures, such as directory trees, etc.

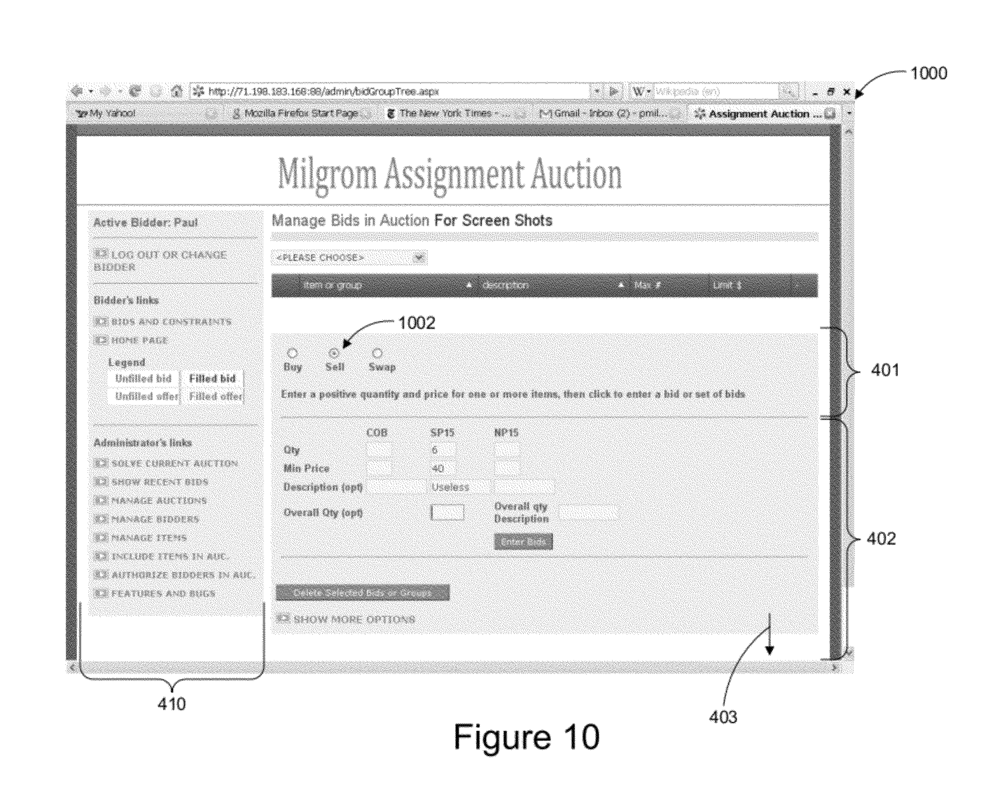

FIG. 10 shows a graphic representation of yet another embodiment of a user interface 1000 generated by the assignment exchange and auction system 100. The user interface 1000 is similar to that described above with reference to FIG. 4. Like reference numerals have been used to indicate like components with the same or similar functionality. In the example shown in FIG. 10, the user another trader, who the auctioneer has determined is qualified to sell. The user is able to create bids and bid groups and in the case shown in FIG. 10 is creating a bid to sell. This other trader uses user interface 1000 to create bids to sell, as indicated by the selection of the sell radio button 1002 in area 401, and enter them into the assignment exchange and auction system 100.

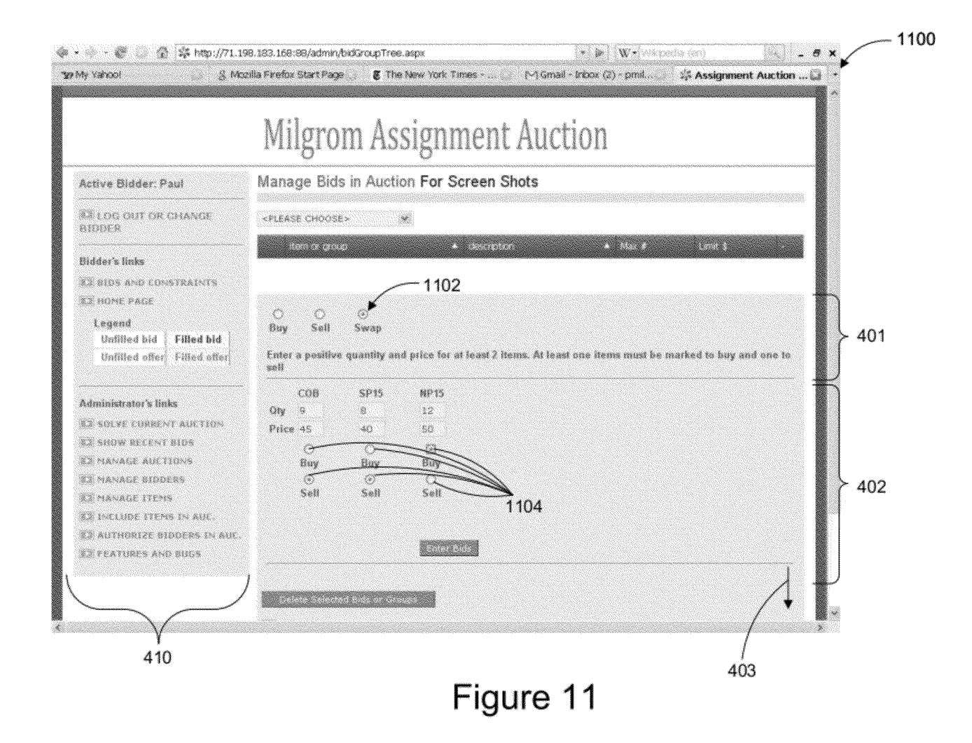

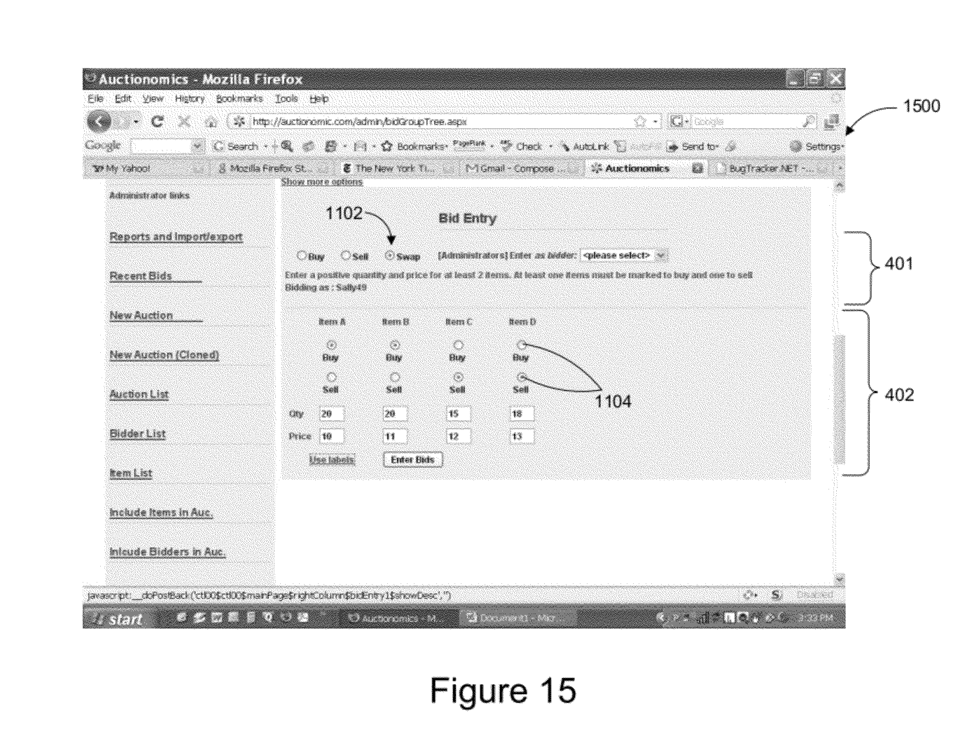

FIG. 11 shows a graphic representation of a user interface 1100 for a swap transaction. In area 401, the swap type transaction is selected as indicated by radio button 1102 active on the swap selection. In area 402, a bidder or user indicates whether it wishes to buy or sell each type of lot in addition to providing the information about the bid as described above with reference to FIGS. 4 and 10. The user interface 1100 a pair of radio buttons 1104 below each bid column for this purpose. In the example shown in FIG. 11, a buyer located in northern California hopes to swap power that it owns at SP15 and COB, from which transmission costs are high, for power at NP 15, for which there are no transmission costs. It will buy at most 12 units of power at NP15 and will sell at most 8 units at SP15 and 9 units at COB. For a Swap bid, in this implementation, the system 100 enforces the constraint that the total quantity of power assigned to this bid is zero, that is, the total amount purchased must be equal to the total amount sold. In another implementation, the maximum net purchase and maximum net sale may be unequal and may be set to values other than zero. FIG. 15 shows a second embodiment for a user interface 1500 for a swap type transaction.

FIGS. 12 and 13 show user interfaces 1200 and 1300 for presenting outcome results after the bids have been entered and the results computed (e.g., auction or exchange performed. The user interfaces 1200 and 1300 each include region 1202 and 1302, respectively, for presenting the bids and it groups that were part of the computed auction or exchange. It should be understood that the views shown in the user interfaces 1200 and 1300 are for a system administrator or auctioneer and therefore showed the bid groups and bids for a plurality of traders (e.g., Paul's bids and Sally's bids). In another embodiment adapted for a particular trader, only the bid groups and bids of that traitor would be displayed in the regionsl202 and 1302 of the user interfaces 1200 and 1300. The present invention advantageously color codes the bids according to type, sell or buy, such that the user may easily distinguish bids within a bid group. In this embodiment of user interfaces 1200 and 1300 and or bids to buy are in blue text and bids or offers to sell are in red text, respectively. Additional color coding is provided by this embodiment of the user interfaces 1200 and 1300 to indicate whether the bids are filled or unfilled as a result of the auction or exchange. The text has white backgrounds for the unfilled bids whether they are to sell or to buy, yellow backgrounds for filled bids to buy and pink backgrounds for filled offers or bids to sell, respectively. Instead of color coding, other indications of transaction type and status may be used, such as text indicia such as different styles or formats, graphical icons, etc. FIG. 13 also shows the results of a swap, which is composed from both bids to buy and offers to sell and is color-coded accordingly. The indicator “Swap” in the “Max #” column indicates the constraint used in this implementation that the total quantities purchased and sold on that branch of the tree must be equal.

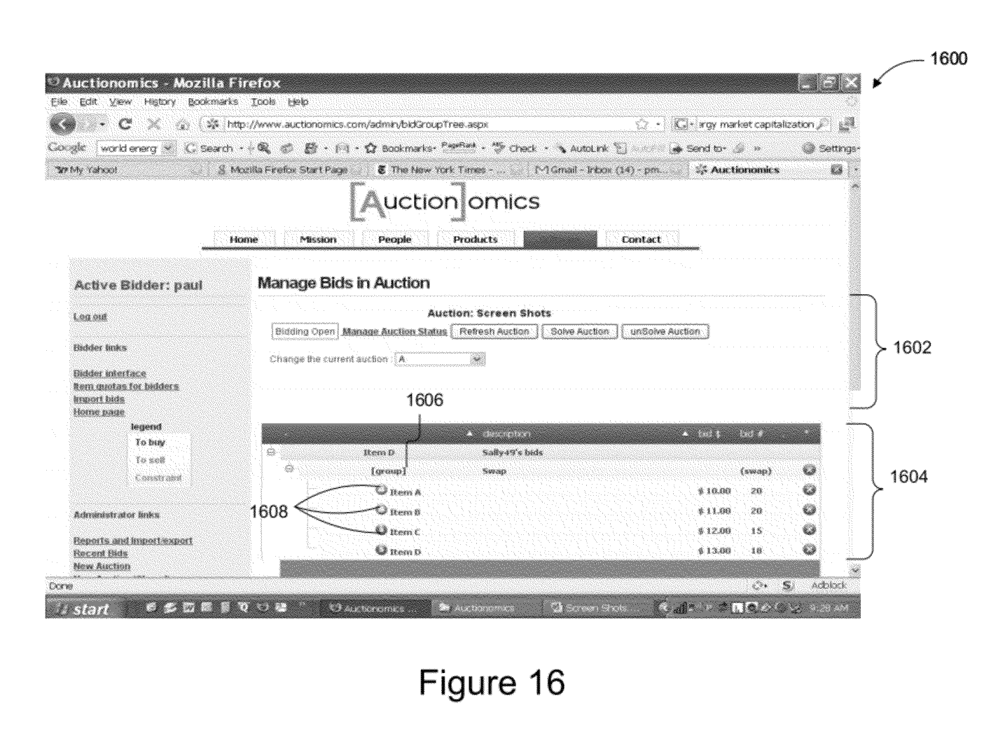

Referring now to FIG. 16, a second embodiment of user interface 1600 generated by assignment exchange and auction system 100 is described. FIG. 16 show the second embodiment of the user interface 1600 after a swap transaction has been entered into the system 100. The user interface 1600 shows a first area 1602 with buttons for performing various management actions related to the auction. The user interface 1600 also has a second area 1604 for presenting the new bid group 1606 that is a swap. This embodiment of the user interface 1600 is particularly advantageous because each row of the bid group 1606 can easily be distinguished as a bid to buy or a bid to sell based on the icons 1608 preceding each item within the hierarchical tree structure of the bid group 1606. For example, bids to buy are indicated with a green icon while bids to sell are indicated with a red icon. The joint use of icons and colors makes the results readable for those with limited color vision or when seen in a black-and-white copy or on a display where colors are not bright. Additional information related to each bid such as price and number of units are also provided in separate columns along the same row.

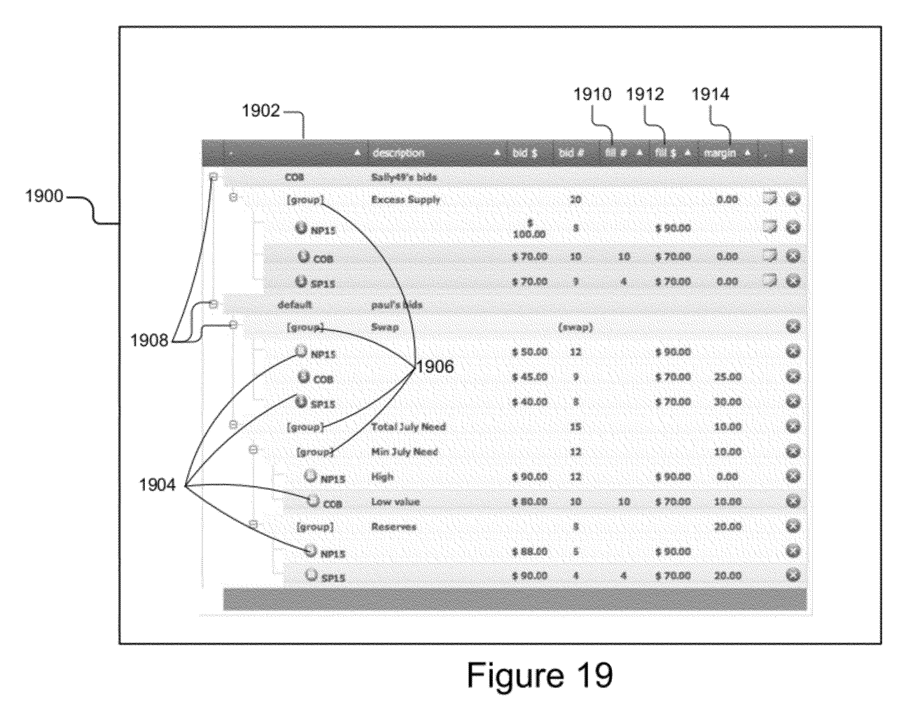

Referring now to FIG. 19, another embodiment of user interface 1900 for presenting outcome results after the bids have been entered and the results computed. The user interface displays a report 1902 generated by bid processor 306. The report 1902 is an illustrative report produced and stored in storage 310. The displayed report 1902 is for the auction administrator and it displays all the bids 1904, all the bid groups 1906, a tree structure 1908 connecting the groups 1906, the awarded quantities for each bid 1910, the market clearing prices 1912, and the margins 1914 for each bid. For bids to buy, the “margin” is computed by first subtracting the market-clearing price from the bid price and then dividing the result by the effectiveness coefficient. For bids to sell, the “margin” is computed by first subtracting the bid price from the market-clearing price and then dividing the result by the effectiveness coefficient. In this example illustrated, the effectiveness coefficient is one. For an individual bidder, the report 1902 might include less information, providing only summary statistics of the bids of others, including information of the types described below. Moreover, the although only margin 1914 is displayed and shown, in other embodiments various other analytical measurements and data may be presented in place of in addition to the column providing the margin 1914 data. In yet other embodiments, the user can define the information presented by the user interface by using menus or tools similar to hiding columns or rows in a spreadsheet. Generally, reports may include the total quantity of each type of lot bought or sold by each participant, the corresponding prices, the quantities of each type of lot that remain unsold, a bidder's total payments, an indicator of which constraints are binding, indicators of the potential change in a bidder's total margin if a constraint had been one unit more or one unit less, indicators of how much slack is in each constraint (“slack” is the difference between the maximum effective quantity and the actual effective quantity allocated), and reports of the market “thickness” showing how much excess supply or demand there would be if some price were higher or lower by a fixed percentage (such as 5%) or a fixed amount (such as $5/unit).

FIG. 14 shows a process 1400 for performing iterated sealed-bid auction or exchange according to one embodiment of the present invention. In step 1401, a system administrator or some other person working with the system 100 sets up an iterated sealed-bid auction, illustrated at 1401. For example, the system administrator inputs commands to the server 202 to set up a new instance of a sealed-bid auction module 234. Typically, a master of ceremonies or an auctioneer is appointed, as indicated in step 1402. The master of ceremonies or auctioneer is a user such as an administrator that is given limited privileges, which privileges include the ability to set up auctions for a specific account, but not to appoint MCs for other accounts, for example. Other limitations may also exist in terms of financial control, etc. In one embodiment, this includes creating a profile, password, user ID, and other information in the system 100 for a particular user to act as the MC. In step 1403, the rights that are granted to the MC are selected, and then in step 1404, an invitation message is sent in the system 100 to the MC. Typically, the MC is an accredited participant or auctioneer in such the system 100. In some cases, the auction house is itself the seller and/or buyer and assigns certain employees to run the auction. In other cases, the auction is provided as Software-as-a-Service (SAS), which is run by some other company, and the auction house is a high-level MC in this case, which in turn, appoints employees to conduct specific auctions. Thus the administrative functionality may be multi-tiered. In step 1405, the MC defines the details of the iterated sealed-bid auction, including items for sale or swap, delivery location, and trader roles, including which participants are permitted to buy or sell each type of item and in what quantities, credit limits (if any) which may restrict the highest total bid, etc. All this information is received by the server 202 and stored in the data storage unit 208. In step 1406 the system 100 on behalf of the MC creates and sends a list of participants (users of the system 100 that access is via a trader system 206A) to be invited, who are, for example, companies desiring to buy, sell, or swap a commodity, customers of a manufacturer, the participants in an electricity network, etc. In step 1407, the invitations are sent to the participants to act as bidders and/or sellers. In some cases, when participants want to swap items, there is no clear distinction between bidders and sellers. Examples include oil producers that are also refiners and may either buy or sell petroleum supplies at different locations, or electricity distributors who own supply contracts that they might sometimes prefer to sell or swap for more highly valued contracts. In other cases, however, there may be a clear distinction between the suppliers (sellers) and users (buyers) of the lots. In step 1408, the participants 1409 use trader systems 206A-206N to enter bids to buy, sell, and/or swap for a given period, and then at a set time, in step 1410 the MC 1411 ends iteration of the sealed-bid auction. Then in step 1412 the allocation module 238 performs mathematical programming calculations, for example the linear programming calculations described in Appendix A, are used to determine the item prices and possibly the tentative goods assignments or, in some cases, vice versa. In step 1413, the results are provided via trader systems 206A-206N to notify all the participants 1409. In one embodiment, this is performed the system 100 such as by sending e-mail messages, Simon messages or text messages.

In some cases, the sealed-bid auction may be operated in two stages or more stages, iteratively, with bidders 1409 permitted to change or improve their bids and groups based on information reported after the first stage. In these cases, the rules and constraints engine 308 determines which bids can be changed and what new bids are allowed.

### DESCRIPTION OF ITERATED SEALED-BID AUCTIONS

First consider an implementation of an iterated sealed-bid auction with two sealed-bid auctions conducted sequentially. A “forward auctions” refers to auctions in which the bidders are potential buyers.

For forward auctions, a two-stage sealed-bid auction is based on two repetitions of the underlying sealed-bid forward auction, separated by information reporting to the bidders. The two stages also allow development of two points on a demand curve. Auctions with more than two stages work similarly, and can allow the development of as many points on a demand curve as the number of stages (or individual sealed-bid auctions) in the iterated sealed-bid auction.

The two-stage auction based on a multi-product sealed-bid auction begins with an initial stage or round operated according to the sealed-bid auction rules. For example, one preferred implementation for a forward auction is the multi-stage version of an auction known variously as the “MaaX auction” or the “assignment auction.” The two-stage and multi-stage versions begin with a standard sealed-bid MaaX/assignment auction as described in the U.S. Patent Application Publication No. 2009/0177555 A1 and U.S. patent application Ser. No. 12/796,552 by Paul R. Milgrom, in which the supply to be offered is given in advance. However, the allocation determined by the usual auction rules is not final. Instead, at the end of the initial stage, the winning bids are identified and some information about them, possibly supplemented by other bid information, is reported to the bidders.

In one implementation of the two-stage sealed-bid auction, all bids made in the first stage are carried forward and remain valid in the second stage. This implements the principle that bids are binding. In addition, certain bids made in the first stage of a forward auction can be improved. In a preferred implementation, an improvement means that the prices associated with the bid can be increased at the next stage. Bids that can be improved in this invention after any stage include winning bids at that stage and may also include other bids that are determined to be close to winning. In a preferred implementation, the auctioneer computes a threshold price (see 1414) for each bid, which is the minimum price that would have made that bid a winning bid, and determines that any bid within X % of its threshold price is close to winning and can be improved at the second stage or sealed-bid auction.

In a preferred implementations, the supplies of items used in the second stage of a two-stage or multi-stage forward auction should be set to be no higher than the supplies used in the preceding stage. Once bids are received, the outcome of the second stage auction is computed using the revised set of bids, the supplies for that stage, and the sealed-bid rules of the underlying sealed-bid multi-item auction. Between stages, or iterated sealed-bid auctions, feedback about the previous stages' outcomes is supplied to the bidders (see 1416).

This two-stage procedure in the iterated sealed-bid auction can be extended to include any number of stages (1-n). In the preferred implementation, there sequence of supplies used across the various stages should form a non-increasing sequence.

The outcomes of the several stages of a two-stage or other multi-stage sealed-bid auction provide demand information corresponding to various levels of supply. The final outcome of the two-stage or other multi-stage sealed-bid auction corresponds to the outcome of one of the several stages, depending on the supply made available in the auction. In one preferred implementation (the “fixed-supply implementation”), the relevant supply will be known in advance and the sequence of supplies may begin with supplies higher than the relevant supply and terminate with the relevant supply; the final allocation is then completely determined by the bids in the last stage. In another preferred implementation, the seller may consider the demand information from several stages in determining what quantity of supply to make available, either according to some pre-specified rule or at the seller's discretion, possibly governed by some limits.

The procedure described above can be converted to a “reverse” auction in the usual way that other “forward” auction are converted to “reverse” auctions. For reverse auctions in comparison to “forward” auctions, the roles of supply and demand are reversed, price improvements are price reductions rather than price increases, and the threshold price for a particular bid is the maximum price that would be winning, rather than the minimum price that would be winning.

The same two-stage and multi-stage rules can also be applied to exchanges. In one preferred implementation, the supply and demand information are each elicited by sequences of demands and supplies in the manner described above and then combined to determine winning bids to buy and sell. If the “forward” and “reverse” auctions are conducted contemporaneously, then after each stage, information about the outcomes of current and previous stages of each auction may be used to determine the supply and demand parameters for the next stage of both the forward and reverse auctions.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

### APPENDIX A

The explanations here are drawn from a published paper “Assignment Messages and Exchanges” by Paul Milgrom (in American Economic Journal: Microeconomics 2009, 1:2, 95-113), the contents of which are incorporated by reference herein.

### I. Assignment Messages

Consider a resource allocation problem with goods indexed by k=1, . . . , K and participants are indexed by n=1, . . . , N. If participants' preferences are quasi-linear, then the utility for a trade is expressed as the value Vₙ(qₙ) of bundle qₙε□^{K} acquired plus any net cash transfer. The set of demanded bundles at price vector p is arg max_{q}_{ₙ}Vₙ(qₙ)−p·qₙ, where qₙ may include both positive and negative components. A direct mechanism must specify a message space for describing Vₙ. The assignment exchange determines qₙ by summing vectors xⱼ for jεJ(n), where j is the serial number of a bid and J(n) is the set of serial numbers for bids by bidder n.

An assignment message describes Vₙ using a collection of bids and a set of constraints. Each bid by bidder n is indexed by a serial number jεJ(n) and consists of a 5-tuple (kⱼ, vⱼ, ρⱼ, lⱼ, uⱼ) where kⱼ identifies the type of product, vⱼ identifies the “value” of the bid, ρⱼ>0 identifies the “effectiveness” and the remaining two terms are lower and upper bounds on quantities: lⱼ≦0≦uⱼ. The role of the effectiveness coefficient, which is to allow arbitrary marginal rates of substitution within certain constraints, will be formalized shortly.

In addition to the bids, participant n's assignment message expresses constraints of two kinds. First are the single product bid group constraints:

$${l}_{kS} \leq {\sum }_{j ∈ S} {x}_{j} \leq {u}_{kS} for S ∈ {T}_{nk} \qquad ( 1 )$$

where Tₙₖ includes all singletons S={j} for which kⱼ=k and may include other subsets of Rₙₖ={jεJ(n)|kⱼ=k}. For the singletons, lₖ_{ⱼ}_{{j}}≡lⱼ. Second are the multi-product bid group constraints indexed by the set Tₙ₀. These are of the form

$${l}_{0 S} \leq {\sum }_{j ∈ S} {ρ}_{j} {x}_{j} \leq {u}_{0 S} for S ∈ {T}_{n 0} . \qquad ( 2 )$$

Unlike the sets used in the single product group constraints, the sets SεTₙ₀ may include bids on multiple products. Also, unlike the sums in (1), those in (2) are weighted sums, with weights equal to the effectiveness coefficients.

To simplify notation, we suppress the subscript n while we are analyzing the reports and preferences of a single bidder; the subscript will reappear later when we analyze allocations for multiple participants. Using the bids and constraints, bidder n's message is interpreted to report a value for any feasible bundle of products q=(q₁, . . . , q_{K}) as follows:

$$V ( q ) = {max}_{x} {\sum }_{j ∈ J ( n )} {v}_{j} {x}_{j} subject to \\ {l}_{kS} \leq {\sum }_{j ∈ S} {x}_{j} \leq {u}_{kS} for S ∈ {T}_{k} , k = 1 , … , K \\ {l}_{0 S} \leq {\sum }_{j ∈ S} {ρ}_{j} {x}_{j} \leq {u}_{0 S} for S ∈ {T}_{0} \\ {\sum }_{\{ j ∈ J ( n ) \vert {k}_{j} = k \}} {x}_{j} = {q}_{k} for k = 1 , … , K \qquad ( 3 )$$

Because the vector (q,x)≡0 satisfies all the constraints in (3), the zero bundle q=0 is feasible. By a theorem of linear programming, the set of vectors q for which the problem is feasible is a closed, bounded, convex set Q⊂ [symbol] and V is a continuous, concave function on that set. The next step is to define assignment messages and certain related concepts.

Definitions.
1. The demand correspondence for V is D(p)=arg max_{qεQ}V(q)−p·q.
2. The indirect profit function for V is π(p) max_{qεQ}V(q)−p·q.
3. The valuation V is substitutable if for all prices p, p′ε [symbol] and all k=1, . . . , K, if D(p)={x} and D(p₋ₖ,p′ₖ)={x′} are singletons and p′ₖ>pₖ, then x′₋ₖ≧x₋ₖ.
4. A collection of sets [symbol] is a tree if (1) for any two non-disjoint sets S, S′εT₅ either S⊂S′ or S′⊂S and (2) [symbol] contains a largest set—the union of all its elements. That largest set is the root of [symbol] .
5. Given a tree of sets [symbol] its extended predecessor function (P) maps each element of [symbol] excluding the root R, into its unique predecessor and maps each jεR into the smallest set S satisfying jεSεT.
6. A bound forest is a collection of trees and associated bounds {T₀, . . . , T_{K}, {(l_{kS},u_{kS})|SεTₖ, k=0, . . . , K}} with all l_{kS}≦0≦u_{kS}. The trees satisfy:
   a. The root of T₀ is R₀=J(n) and, for k=1, . . . , K, the root of Tₖ is Rₖ={jεJ(n)|kⱼ=k}.
   b. For k=1, . . . , K, the terminal nodes of tree Tₖ are the singleton sets {j} with jεJ(n) and kⱼ=k.
   c. All bounds except the root bounds are finite, 0≧l_{S}>−∞ and 0≦u_{S}<+∞, but the bounds on the roots may be infinite, 0≧l_{R}_{ₖ}≧−∞ and 0≦u_{R}_{ₖ}≦+∞.
   d. For any singleton set {j}ε [symbol] ₖ_{ⱼ},lₖ_{ⱼ}_{{j}}=lⱼ.
7. An assignment message consists of a collection of bids (kⱼ, vⱼ, ρⱼ, lⱼ, uⱼ) and a bound forest {T₀, . . . , T_{K}, {(l_{kS},u_{kS})|SεTₖ, k=0, . . . , K}}
8. A basic assignment message is an assignment message with each ρⱼ=1 and with all bounds l_{kS} and u_{kS} integers.
9. An assignment exchange is a mechanism mapping profiles of assignment messages for each bidder n to an outcome pair (q₁*, . . . , q_{N}*, p*) where q*εarg max_{{q|q}_{ₙ}_{εQ}_{ₙ}_{}}Σₙ₌₁^{N}Vₙ(qₙ) subject to Σₙ₌₁^{N}qₙₖ=0 for k=1, . . . , K and p* is a supporting price vector, that is, for n=1, . . . , N, q*ₙεargmax_{qεQ}_{ₙ}Vₙ(q)−p*·q (equivalently, p*εarg minₚ πₙ(p)+p·qₙ*).
10. A basic assignment exchange is an assignment exchange in which the messages are restricted to be basic assignment messages.

The basic assignment messages form an extension of the set of messages allowed by the Shapley-Shubik mechanism. In the Shapley-Shubik mechanism, each participant occupies just one role, as a buyer or a seller. Each seller message includes just one bid (|J(n)|=1) and each buyer message includes just one bid for each product. If participant n is a seller, then the constraints on its one bid are l₁=−1 and u₁=0. If participant n is a buyer, then its constraint bounds for each bid are lⱼ=0 and uⱼ=1 and its one group constraint has bounds l_{R}_{ₙ₀}=0 and u_{R}_{ₙ₀}=1. The basic assignment message space extends this Shapley-Shubik message space by allowing more bids, more constraints, and general integer bounds.

The three main results of this section can now be stated. Proofs follow just below.

Theorem 1. If participant n reports an assignment message, then its valuation V:q→ [symbol] as given by (3) is continuous, concave and substitutable and its indirect profit function is submodular.

Theorem 2. If every participant n reports a continuous, concave substitutable valuation on a convex, compact set Qₙ, then the set of market-clearing prices for the report profile is arg minₚΣₙ₌₁^{N}πₙ(p). This set is a non-empty, closed, convex sublattice.

Theorem 3. If every participant reports a basic assignment message, then there is an integer vector [symbol] ₙ₌₁^{N}Vₙ(qₙ) subject to Σₙqₙₖ=0 for all k.

The proof of theorem 1 makes use of the following results, which are also of independent interest.

Lemma 1. Suppose that the valuation function V is such that the corresponding indirect profit function π is well defined. Then V is substitutable if and only if its indirect profit function π is submodular.

Lemma 2. Suppose π(p)=min_{z} g(z) subject to (z, p)εS, where g is submodular, S is a sublattice in the product order, and p is a parameter. Then, π is submodular.

Proof of Lemma 1. Since π is convex on [symbol] , it is locally Lipschitz and differentiable almost everywhere. By Hotelling's lemma, the demand set is a singleton D(p)={x(p)} at exactly those points of differentiability and πₖ(p)≡∂π(p)/∂pₖ=−xₖ(p). Substitutability is equivalent to the condition that for k=1, . . . , K, x₋ₖ(p) non-decreasing in pₖ. Submodularity is equivalent to the condition that on the same domain, πₖ(p) is non-increasing in p_{k′} for k′≠k. QED

Proof of Lemma 2. Let p and p′ be two price vectors and let z and z′ be corresponding optimal solutions, so that π(p)=g(z), π(p′)=g(z′), and (z, p), (z′, p′)εS. Since S is a sublattice, (ẑz′, p [symbol] p′),(z [symbol] z′, p [symbol] p′)εS. By the definition of π, π(p [symbol] p′)≦g(z [symbol] z′) and π(p [symbol] p′)≦g(z [symbol] z′). Since g is submodular, g(z [symbol] z′)+g(z [symbol] z′)≦g(z)+g(z′). Hence, π(p [symbol] p′)+π(p [symbol] p′)≦π(p)+π(p′). QED

Proof of Theorem 1. Let Pₖ denote the extended predecessor function associated with tree Tₖ. Let ρ_{{j}}=ρⱼ and ρ_{S}=1 if |S|≠1. We adopt the convention that if a set is empty, the sum it indexes is zero. Using the tree structures, for k=0, . . . , K and SεTₖ, one can define variables as follows:

$${x}_{kS} = \{ \begin{matrix}{\sum }_{{S}^{′} ∈ {P}_{0}^{- 1} ( S )} {ρ}_{{S}^{′}} {x}_{{S}^{′}} & for k = 0 \\ {\sum }_{{S}^{′} ∈ {P}_{k}^{- 1} ( S )} {x}_{{S}^{′}} & for k = 1 , … , K\end{matrix}$$

Using this augmented vector x, and with the notational convention that x₀ⱼ≡xₖ_{ⱼ}ⱼ≡xⱼ, rewrite (3) as:

$$V ( q ) = {max}_{x} {\sum }_{j ∈ J ( n )} {v}_{j} {x}_{j} subject to \\ - {x}_{kS} + {\sum }_{{S}^{′} ∈ {P}_{k}^{- 1} ( S )} {x}_{{kS}^{′}} = 0 for S ∈ {T}_{k} , k = 1 , … , K \\ {x}_{0 S} - {\sum }_{{S}^{′} ∈ {P}_{0}^{- 1} ( S )} {ρ}_{{S}^{′}} {x}_{0 {S}^{′}} = 0 for S ∈ {T}_{0} \\ {l}_{kS} \leq {x}_{kS} \leq {u}_{kS} for S ∈ {T}_{k} , k = 0 , … , K \\ {x}_{{kR}_{k}} = {q}_{k} for k = 1 , … , K \qquad ( 4 )$$

The indirect profit function is:

$$π ( p ) = {max}_{q ∈ {ℜ}^{K}} V ( q ) - p \cdot q = {max}_{x} {\sum }_{j ∈ J ( n )} {v}_{j} {x}_{j} - {\sum }_{k = 1}^{K} {p}_{k} {x}_{{kR}_{k}} \\ subject to \\ - {x}_{kS} + {\sum }_{{S}^{′} ∈ {P}_{k}^{- 1} ( S )} {x}_{{kS}^{′}} = 0 for S ∈ {T}_{k} , k = 1 , … , K \\ {x}_{0 S} - {\sum }_{{S}^{′} ∈ {P}_{0}^{- 1} ( S )} {ρ}_{{S}^{′}} {x}_{0 {S}^{′}} = 0 for S ∈ {T}_{0} \\ {l}_{kS} \leq {x}_{kS} \leq {u}_{kS} for S ∈ {T}_{k} , k = 0 , … , K \qquad ( 5 )$$

Applying the duality theorem of linear programming, with λ_{S}^{u} and λ_{S}^{l} is the shadow prices on the upper and lower bound constraints and μ_{kS} the shadow prices on equality constraints:

$$π ( p ) = {min}_{λ , μ} {\sum }_{k = 0}^{K} {\sum }_{S ∈ {T}_{k}} ( {u}_{kS} {λ}_{kS}^{u} - {l}_{kS} {λ}_{kS}^{l} ) \\ subject to \\ - {ρ}_{j} {μ}_{0 {P}_{0} ( j )} + {μ}_{{kP}_{k} ( j )} \geq {v}_{j} for j ∈ {R}_{k} , k = 1 , … , K \\ {λ}_{kS}^{u} - {λ}_{kS}^{l} + {μ}_{{kP}_{k} ( S )} - {μ}_{kS} \geq 0 for k = 1 , … , K , S ∈ {T}_{k} - \{ {R}_{k} \} \\ {λ}_{0 S}^{u} - {λ}_{0 S}^{l} - {ρ}_{S} {μ}_{0 {P}_{0} ( S )} + {μ}_{0 S} \geq 0 for S ∈ {T}_{0} - \{ {R}_{0} \} \\ {λ}_{{kR}_{k}}^{u} - {λ}_{{kR}_{k}}^{l} - {μ}_{{kR}_{k}} \geq - {p}_{k} for k = 1 , … , K \\ {λ}_{0 {R }_{0}}^{u} - {λ}_{0 {R}_{0}}^{l} + {μ}_{0 {R}_{0}} \geq 0 \qquad ( 6 )$$

For k=0, . . . , K and SεTₖ, define functions f_{kS}(z)≡u_{kS} max(0,z)+l_{kS}min(0,z). Notice that these functions f_{kS} are convex and that, because either λ_{kS}^{u}=0 or λ_{kS}^{l}=0 (the upper and lower bound constraints on x_{kS} cannot both be binding), f_{kS}(λ_{kS}^{u}−λ_{kS}^{l}=u_{kS}λ_{kS}^{u}−l_{kS}λ_{kS}^{l}. Define θ_{kS}=μ_{kS}−(λ_{kS}^{u}−λ_{kS}^{l}) for k=1, . . . , K and θ_{0S}=μ_{0S}+(λ_{0S}^{u}−λ_{0S}^{l}). Substituting into (6) results in the following:

$$π ( p ) = {min}_{λ , μ} {\sum }_{k = 1}^{K} {\sum }_{S ∈ {T}_{k}} {f}_{kS} ( {u}_{kS} - {θ}_{kS} ) + {\sum }_{S ∈ {T}_{0}} {f}_{0 S} ( {θ}_{0 S} - {μ}_{0 S} ) \\ subject to \\ - {ρ}_{j} {μ}_{0 {P}_{0} ( j )} + {μ}_{{kP}_{k} ( j )} \geq {v}_{j} for j ∈ {R}_{k} , k = 1 , … , K \\ {μ}_{{kP}_{k} ( S )} - {θ}_{kS} \geq 0 for k = 1 , … , K , S ∈ {T}_{k} - \{ {R}_{k} \} \\ - {ρ}_{S} {μ}_{0 {P}_{0} ( S )} + {θ}_{0 S} \geq 0 for S ∈ {T}_{0} - \{ {R}_{0} \} \\ - {θ}_{{kR}_{k}} \geq - {p}_{k} for k = 1 , … , K \\ {θ}_{0 {R}_{0}} \geq 0 \qquad ( 7 )$$

Let C=Σₖ₌₀^{K}|Tₖ| be the total number of constraints included in bidder n's assignment message. Let (θ, μ, p)ε [symbol] be a vector listing the dual variables and prices. Using the usual product order, treat [symbol] as a lattice. Since the f_{kS} functions are convex, the objective in problem (7) consists of a sum of submodular functions of (θ,μ). Since the objective is a sum of submodular functions of (θ,μ), it, too, is a submodular function of (θ,μ). Also, by inspection, each constraint in (7) defines a sublattice of [symbol] for some one or two variables among (θ,μ,p) and hence of the higher dimensional space of vectors (θ,μ,p). Since an intersection of sublattices is a sublattice, the constraints in (7) define a sublattice.

Thus, (7) takes the form min_{z} g(z) subject to (z, p)εS where g is submodular and S is a sublattice. Lemma 2 applies, so π is submodular. Lemma 1 then applies, so V is substitutable. QED

Proof of Theorem 2. Since the corresponding primal problem can be represented as a continuous concave maximization on a compact set, the maximum exists and coincides with the minimum of the dual. Since the valuations are concave, the set of market-clearing prices is the set of solutions to the dual problem: arg minₚΣₙ₌₁^{N}πₙ(p). Since each πₙ is continuous and convex, the set of minimizers of the dual problem is closed and convex. Since each πₙ is submodular, by a theorem of Topkis (1978), the set of minimizers of the dual problem is a sublattice. QED

Proof of Theorem 3. We show something stronger than claimed by the theorem, namely, that there is an integer solution x* to the problem that determines the goods assignments:

$${max}_{x} {\sum }_{n} {\sum }_{j ∈ J ( n )} {v}_{j} {x}_{j} subject to \\ - {x}_{nkS} + {\sum }_{{S}^{′} ∈ {P}_{nk}^{- 1} ( S )} {x}_{{nkS}^{′}} = 0 for S ∈ {T}_{nk} , \\ k = 1 , … , K , n = 1 , … , N \\ {x}_{n 0 S} - {\sum }_{{S}^{′} ∈ {P}_{n 0}^{- 1} ( S )} {x}_{n 0 {S}^{′}} = 0 for S ∈ {T}_{n 0} , n = 1 , … , N \\ {l}_{nkS} \leq {x}_{nkS} \leq {u}_{nkS} for S ∈ {T}_{nk} , k = 0 , … , K , n = 1 , … , N \\ {\sum }_{n} {x}_{{nkR}_{nk}} = 0 for k = 1 , … , K \qquad ( 8 )$$

The sign restrictions l_{nkS}≦0 and u_{nkS}≧0 ensure that x≡0 satisfies the constraints of the problem, so the problem is feasible. The individual bounds on each xⱼ imply that the constraint simplex is bounded. For a feasible, bounded linear program, there is always an optimal solution at a vertex of the constraint simplex. Hence, to prove the theorem, it is sufficient to show that every vertex of the simplex defined by the constraints in (8) is an integer vector.

Each vertex of the constraint simplex is determined by a set of binding upper and lower bound constraints of the form x_{S}=u_{S} or x_{S}=l_{S} and the equation Ax=0, which describes the equality constraints in (8). Fix any vertex and denote the right-hand sides of the binding upper and lower bound constraints by ū and l̅, which by hypothesis are integer vectors. Write the vector x in the form (\hat{x}, x̅ₗ, x̅ᵤ), to express the binding constraints by x̅ₗ= l̅, x̅ᵤ=ū. Eliminating the columns corresponding to the variables x̅ₗ and x̅ᵤ, the remaining variables are determined by a system of equations Â\hat{x}=b, where Â is the submatrix of A that results from eliminating the columns corresponding to x̅ₗ and x̅ᵤ and b is the integer vector that results from substituting the given values of x̅ₗ and x̅ᵤ into Ax=0. It is now sufficient to show that for every non-singular submatrix Â of A and every integer vector b, the solution to Â\hat{x}=b is an integer vector. For this, it suffices to show that A is totally unimodular.

According to a theorem of Hoffman (see Heller and Tomkins (1956)), a matrix is totally unimodular if all the entries of A are elements of the set {0,+1,−1}, if each column of A has at most two non-zero entries, and if no two non-zero entries in any column have the same sign. To verify the Hoffman conditions, examine the columns of (8) corresponding to the different variables x_{nkS}. For the root S=Rₙ₀ of a Tₙ₀ tree for some participant n, x_{n0S} appears in only one equality constraint in (8) and so has a single entry in its column. For k≠0, the variables x_{nkR}_{ₙₖ} appears just twice: once in its defining equation and again in one of the market-clearing constraints, and its two coefficients have opposite signs. For k≠0 and all sets SεTₙₖ−{Rₙₖ}, x_{nkS} appears just twice: with coefficient −1 in the equation defining x_{nkS} and with coefficient +1 in the equation defining x_{nkP}_{ₙₖ}_{(S)}. For all sets SεTₙ₀−{Rₙ₀}, x_{n0S} appears just twice: with coefficient +1 in its defining equation and with coefficient −1 in the equation defining x_{n0P}_{ₙ₀}_{(S)}. The last variables are the xⱼ variables. Recall that by our extended definition of predecessor, jεP⁻¹ₙₖ(S) for exactly two sets, one in Tₙₖ_{ⱼ} and one in Tₙ₀, with coefficient +1 in one case and −1 in the other. Hence, the Hoffman conditions are satisfied. QED

### II. Partial Converse to Theorems 1 and 2

The structure of assignment messages allows bidders to report values and effectiveness coefficients without limitations but restricts the form of constraints to be a bound forest. The tree constraints can be imposed in software to implement the exchange. This section shows that if one fails to impose the constraint that Tₙ₀ is a tree, then theorems 1 and 2 become invalid.

The main idea can be illustrated with the example of a buyer for whom the lower bounds lⱼ and l_{kS} are all zero. Suppose that there are three goods and that this buyer has three bids, j=1,2,3, each with vⱼ=1 and kⱼ=j, all constrained so that 0≦xⱼ≦2. Suppose that the multi-product groups constraints in the problem are x₁+x₂≦3 and x₂+x₃≦3, violating the tree structure. Then, for the price vector (0,1,2), the corresponding demand is (2,1,2) and for the price vector (3,1,2), the corresponding demand is (0,2,1): raising the price of good 1 reduces the demand for good 3, violating the substitutes condition.

It is a short step from this example to the following theorem, the proof of which is omitted.

Theorem 4. If the set Tₙ₀ is not a tree, then there exist bids and integer bounds for each SεTₙ₀ such that the valuation Vₙ is not a substitutes valuation, the indirect profit function πₙ is not submodular, and the set of market-clearing prices (for this one bidder problem) is not a sublattice.

### III. Tightness

A simplified direct mechanism is a one with a restricted message space. A mechanism is a triple (N,M,ω), where N is the set of participants, M is the product space of message profiles, ω:M→Ω, and Ω is the set of possible outcomes. For tightness analysis, it is assumed that Ω=×_{nεN}Ωₙ, where each Ωₙ is a topological space, and that each player n's payoff is by uₙ(ωₙ), where the payoff function uₙ is continuous. A simplified mechanism is tight if for all utility profiles u=(uₙ)_{nεN} and every ε≧0, every pure-strategy profile that is an ε-Nash equilibrium of the simplified mechanism is also an ε-Nash equilibrium of the original, extended mechanism.

For this application, we take ωₙ=(qₙ, p), which means that each participant may care about his goods assignment and about the prices, but not the goods assigned to others. In standard equilibrium theory, preferences for a participant n depend only on (qₙ,p□qₙ)—his goods assignment and payment. By including the price vector in a more general way, we allow that a participant may prefer, for example, that its competitor's product commands a low price or that its partner's product commands a high price. In particular, we allow that a participant's actual preferences may not be describable using assignment messages.

The next theorem applies not just to the general assignment exchange, but also to mechanisms that limit the messages participants can use to a subset of the assignment messages. To describe the permissible limitations on messages, let us say that an assignment message mₙ is minimally constrained if its only finite constraint bounds (l_{S}, u_{S}) correspond to the singleton sets S={j}. An assignment message is simple if it is minimally constrained and if for every product k, it includes at most two bids j: |{jεJ(n):kⱼ=k}|≦2.

Theorem 5. Any Walrasian exchange in which each bidder n's message space contains only assignment messages and contains all simple assignment messages is a tight simplification of the full Walrasian exchange.

Proof. Let \hat{M}ₙ be bidder n's simplified message space and let Mₙ be the full Walrasian message space. According to the Simplification Theorem of Milgrom (2008), it is sufficient to establish that the simplified message space has the outcome-closure property, which is the following: For every message profile in \hat{m}₋ₙε\hat{M}₋ₙ, every mₙεMₙ, and every open neighborhood O of ωₙ (\hat{m}₋ₙ,mₙ), there exists \hat{m}ₙε\hat{M}ₙ such that ωₙ(\hat{m})εO. We now establish that the proposed simplification has this property.

Fix a participant n and messages \hat{m}₋ₙε\hat{M}₋ₙ and mₙεMₙ. Let (p,q)≡ω(\hat{m}₋ₙ,mₙ). Let σₙₖ=sign(qₙₖ)ε{−1,0,1} and fix ε>0. Under the hypothesis of the theorem, n's message space includes the following simple assignment message \hat{m}ₙ with bids j=1, . . . , 2K as follows. For k=1, . . . , K, k₂ₖ₋₁=k, v₂ₖ₋₁=pₖ+σₙₖε, v₂ₖ=pₖ−σₙₖε, u₂ₖ₋₁=u₂ₖ=max(0,qₙₖ) and l₂ₖ₋₁=l₂ₖ=min(0,qₙₖ). The message \hat{m}ₙ specifies no other finite bounds. Let (\hat{p},\hat{q}) be the competitive equilibrium outcome selected by the mechanism when the message profile is \hat{m}.

Since (p,q) is a competitive equilibrium for the report profile (\hat{m}₋ₙ,mₙ) qₙ solves maxₓ_{ₙ} max_{{x}_{_{−n}}_{|Σ}_{_{l≠n}}ₓ_{ₙ}_{=0}} (Vₙ(xₙ|mₙ)+Σ_{l≠n}Vₗ(xₗ|\hat{m}ₗ)). And since n demands qₙ at prices p, (p,q) is also a competitive equilibrium for report profile \hat{m}. From that and the fact that ε>0, qₙ uniquely solves maxₓ_{ₙ} max_{{x}_{_{−n}}_{|Σ}_{_{l≠n}}ₓ_{ₙ}_{=0}} (Vₙ(xₙ|\hat{m}ₙ)+Σ_{l≠n}Vₗ(xₗ|\hat{m}ₗ)). Hence, even though there may be multiple competitive equilibria for the message profile \hat{m}, all assign the bundle qₙ to participant n: \hat{q}ₙ=qₙ. Moreover, since every market-clearing price vector support this choice by n, the price vector \hat{p} must satisfy pₖ−ε≦\hat{p}ₖ≦pₖ+ε for every product k. Since ε can be arbitrarily small, the outcome closure property is proved. QED

### IV. Additional Connections

One connection is between the assignment exchange and single product exchanges. If K=1, the assignment exchange reduces to what the literature calls a double-auction. Each participant's report describes a step-function supply or demand curve and these are intersected to determine market-clearing prices and quantities. In case the market-clearing prices or quantities are not unique, any selection rule is consistent with the assignment exchange. In one-sided cases (with just bids to buy and a fixed supply, or bids to sell and a fixed demand), the kinds of problems found in share auctions (Wilson (1979)) can present themselves. Typical solutions to these problems, such as proposed in McAdams (2002) and Kremer and Nyborg (2004), can be adapted to the assignment exchange.

Another connection is to the Vickrey auction. In such an auction, if a participant n acquires a single good k, it pays the opportunity cost of that good, which is equal to the incremental value of one additional unit of good k to the coalition of other participants. In the linear program for the basic assignment exchange, the lowest market-clearing price pₖ for good k is its shadow price—the amount by which the optimal value would increase if an additional unit of good k were made available to the coalition of all players. If participant n has demand for just one unit in total and acquires a unit of good k, then the additional unit for the coalition of all participants is actually assigned to someone besides n, so pₖ is the increased optimal value of that unit to the other participants—n's Vickrey price.

Theorem 6. Suppose that some participant n bids to acquire at most one unit in a basic assignment exchange and that the exchange selects the price vector p that is the minimum market-clearing price vector. Then, if n acquires a unit of good k, the price pₖ is equal to n's Vickrey price for k.

A symmetric statement can be made about participants who sell one unit and exchanges that select the maximum market-clearing price vector.

### V. From Theory to Practice

As described in the introduction, the implementation of multi-product clock auctions can be handicapped by finite bid increments, scheduling issues, and short market periods. These are typical among the many issues that arise in any applied market design.

The two main practical limitations of assignment exchanges are associated with their enforced simplification of preference reports and the paucity of information they reveal to bidders during the auction. The latter may be significant when there is some common value element in the environment or when a bidder's payoff depends on the trades made by other bidders.

Before discussing the limitations of the assignment message space, however, it is appropriate to recognize cases in which even the simplest basic assignment messages can be effective. Suppose, for example, that an electricity buyer n can purchase power from any of three sources, 1, 2 or 3, subject to transmission costs (t₁, t₂, t₃) and transmission capacity limits (U₁, U₂, U₃. If n needs to buy P units of power and the value per unit is α, then bids j=1,2,3 with kⱼ=j, vⱼ=α−tⱼ, uⱼ=Uⱼ, Iⱼ=0 and one constraint for S={1,2,3} with u_{S}=P and l_{S}=0 accurately expresses the bidder's demand. If there are also transmission losses to account for, the bidder can handle those by setting ρⱼ<1; otherwise, ρ₁=ρ₂=ρ₃=1.

In the same setting, it might happen that the buyer has already acquired all of its power need for some time period but would be willing to sell up to β units power at A in exchange for β units at B or C, provided the price is right. This swap can be encoded with three bids and the constraints: 0≧x_{A}≧−β, x_{B},x_{C}≧0, x_{A}+x_{B}+x_{C}=0 (which is encompassed by the theory because it can be expressed using upper and lower bounds: 0≦x_{A}+x_{B}+x_{C}≦0).

Swap bids have the potential to add liquidity to an exchange hindered by lack of volume. Investigating this fully is beyond the scope of this paper: it requires a theory of why owners do not constantly participate in and provide liquidity to markets. Nevertheless, it is clear that in a market with modest liquidity, swaps encourage participation by limiting the risk that one part of an intended transaction might be executed without the other parts. For example, with separate markets, a swapper with a budget limit might have to sell one commodity before buying the other in order to raise funds to transact, leaving the swapper exposed to the risk of not finding a seller for the other part of the planned transaction. By eliminating such risks, swaps make participation safer, increasing liquidity.

The power of simple assignment messages in the examples given above is important because simplicity is often a design goal. One might simplify the general assignment exchange by limiting the number of bids, constraints, or levels in the constraint trees. Theorems 1, 2, 3 and 5 have been constructed to apply even to exchanges that incorporate additional simplifications.

One kind of common constraint that is not fully reflected in theorem 5 arises when the exchange limits a participant's role. For example, only certain parties may be qualified sellers of particular goods, as implemented by a restriction limiting when lⱼ<0 is permitted. This can be significant for conclusions about tightness, and it is natural to investigate extensions of theorem 5 by imposing similar restrictions on the related Walrasian exchange. I leave that task for others.

Another common limitation imposed by operators is a credit limit on buyers. Whether this is implemented as a limit on the maximum acceptable bid from a bidder or as a limit on the maximum quantities that can be demanded, the result is simply to restrict the bidder to a subset of the assignment message space, so the theorems continue to apply.

When bidder market power in an auction is alleged, it may be good policy to limit the total quantity of all goods or only of certain goods k purchased by some set of bidders. Such a policy leads to constraints that are complex because they combine bids across bidders. One approach is by product redefinition. For example, if the operator wants to limit bidders 1 and 2 to purchase no more than half of the available units of good 1, it can accomplish that by splitting good 1 into types 1A and 1B and restricting bidders 1 and 2 from bidding on type 1B. This procedure has precedent: it is similar to the set-asides used by the US Federal Communications Commission to restrict purchases by incumbents in some auctions.

Whether the assignment messages are sufficiently encompassing is likely to vary by application. Certainly, scale economies and complements among lots are sometimes important and cannot generally be solved merely by redefining lots. For example, in electricity, generating plants typically have large fixed costs that require all or nothing decisions about whether to use their power capacity. While such limits are not directly expressed using assignment messages, it is often possible to use the assignment exchange as part of a solution. One ad hoc procedure is to operate the exchange in two or more rounds to allow preliminary price discovery to guide bids at the final round. This does not entirely eliminate the fixed cost problem, but it may sometimes mitigate it. Staged dynamics of this sort may also be helpful when there are important common value elements or when bidders can invest in information gathering during the process, as in Compte and Jehiel (2000) or Rezende (2005).

A more exact procedure incorporates the assignment exchange as an element within a general combinatorial auction or exchange. For example, participants might be allowed to report fixed costs of transacting in addition to their assignment messages. Doing that would lead to a two-stage problem, in which finding the right set of participants is a combinatorial optimization problem, but finding the allocation for a given set of participants is an assignment exchange problem. Similarly, in the airline slot problem, if there is no single time T that is covered by all the relevant intervals, it may still be possible to organize the optimization around a limited number of such times—the combinatorial part of the problem—and to allow the assignment exchange to solve the remaining part.

Three key properties of assignment and basic assignment messages—that they are simple to use and express only substitutable preferences and that basic assignment messages lead to efficient integer solutions—make them potentially valuable for simplifications of other mechanisms in addition to the Walrasian exchange. For example, two principal disadvantages of Vickrey auctions—complexity of the message space and “low” seller revenues (less than in any core allocation)—hinge on either the complexity of the message space and the availability of messages that report non-substitutable values, respectively. A simplified Vickrey auction in which bidders are limited to reporting assignment messages escapes these disadvantages. As another example, consider assignment problems with discrete goods and rules against cash transfers, such as the problems of assigning students to courses or flight attendants to routes. In such cases and assuming that basic assignment messages describe ordinal preferences, by maximizing welfare-weighted sums of assignment values using linear programming, one identifies all and only integer efficient solutions. And, if budget constraints are imposed to find competitive equilibrium solutions, the resulting fractional allocations can be shown to correspond to a randomization over integer solutions.

As described in the introduction, direct, sealed-bid mechanisms enjoy important advantages compared to ascending or descending auctions, particularly for time-sensitive applications. Assignment exchanges, in particular, are tight, simple to use, fast to execute, and precise in determining both equilibrium prices and goods assignments. Assignment messages provide a compact expression of a useful set of substitutable preferences for a range of applications and the basic assignment messages ensure that equilibrium assignments entail only integer quantities. The assignment exchange design is robust, in the sense that its key properties remain even when the assignment message space is further restricted in any way that does not eliminate any simple assignment messages, and maximal in the sense no extension of the bid tree constraint architecture is possible without destroying the key substitutes property of the message space. In combination, these attributes make the assignment exchange an attractive candidate for the many practical applications in which the goods or items to be assigned are substitutes.

What is claimed is:

1. A computer-implemented method for implementing iterated sealed-bid auctions for determining a supply curve or demand curve for use in assigning, pricing, or exchanging multiple types of lots performed by one or more computing devices, the method comprising:
implementing an initial sealed-bid auction in which multiple bidders submit binding sealed-bids to buy, sell, or swap;
generating an information feedback to bidders based on the initial sealed-bid auction;
determining a selection of bids from the initial sealed-bid auction for improvement, where each bid in the selection is determined to satisfy one of three criteria, including 1) to be provisionally winning, 2) to be close enough to be provisionally winning, and 3) to be within range of a relevant threshold price for the sealed-bid auction;
implementing a subsequent sealed-bid auction in which bids from two groups are used, including a) sealed bids from the initial sealed-bid auction that were not improved and b) sealed bids from the initial sealed-bid auction that were improved.

2. A computer-implemented method according to claim 1, wherein the initial sealed-bid auction has multiple bidders submitting binding sealed-bids to buy, with a given supply quantity that is either known or unknown to the bidders.

3. A computer-implemented method according to claim 1, further comprising:
providing feedback to the bidders in the initial sealed-bid auction by computing equilibrium quantities and prices that would arise if the supplied quantity were to be increased according to a given function.

4. A computer-implemented method according to claim 1, further comprising:
providing feedback to the bidders in the initial sealed-bid auction by computing threshold prices and equilibrium quantities that would arise if the supplied quantity were to be increased according to a given function.

5. A computer-implemented method according to claim 1, wherein up to a predetermined number of sealed-bid auctions are iteratively implemented, wherein the predetermined number is greater than two.

6. A computer-implemented method according to claim 1, wherein up to a predetermined number of sealed-bid auctions are iteratively implemented, wherein the predetermined number is two.

7. A computer-implemented method according to claim 1, wherein up to a predetermined number of sealed-bid auctions are iteratively implemented, wherein in the final sealed-bid auction, results obtained constitute a final allocation.

8. A computer-implemented method according to claim 1, wherein up to a predetermined number of sealed-bid auctions are iteratively implemented, wherein in results obtained from each of the sealed-bid auctions are used to generate a supply curve.

9. A computer-implemented method according to claim 1, wherein up to a predetermined number of sealed-bid auctions are iteratively implemented, wherein results obtained from each of the sealed-bid auctions are used to generate a demand curve.
